(19) United States
(12) Patent Application Publication
(10) Pub. No.: US 2016/0335848 A1
(43) Pub. Date: Nov. 17, 2016

(54) PERFORMANCE BASED MARKETING SYSTEM INCORPORATING A GAME

(71) Applicant: Christopher Mayes, Vestal, NY (US)

(72) Inventor: Christopher Mayes, Vestal, NY (US)

(21) Appl. No.: 15/223,035

(22) Filed: Jul. 29, 2016

Related U.S. Application Data
(63) Continuation-in-part of application No. 14/340,905, filed on Jul. 25, 2014.
(60) Provisional application No. 61/858,322, filed on Jul. 25, 2013.

(51) Int. Cl. G07F 17/32; G06F 17/30

(52) U.S. Cl. CPC G07F 17/3255; G06F 17/3053; G07F 17/3211; G07F 17/3225

(57) ABSTRACT

A performance based marketing system incorporating a game, especially a tagging game wherein participants possess targets having a unique identification code and wherein one participant (marksman) scans or otherwise reads a target associated with another participant (mark). Scan information is sent to a game server where scan data is verified and recorded. Points are awarded to both the marksman and the mark based on game rules. Participants may be part of a group, the group typically having additional rules for awarding scan points. Point tallies may be kept and participants rank ordered for both marksman points and mark points. A game typically has a predetermined duration. At the end of a game, prizes may be awarded. Businesses may participate and individually create additional rules that govern the awarding of points.

### RELATED PATENT APPLICATIONS

This patent application is a Continuation-in-Part of U.S. Provisional Patent Application Ser. No. 61/858,322, filed Jul. 25, 2013, and to U.S. patent application Ser. No. 14/340,905 for SOCIAL NETWORKING AND MARKETING SERVICE PLATFORM filed Jul. 25, 2014, both of which are hereby incorporated herein in their entirety by reference.

### FIELD OF THE INVENTION

The invention relates to marketing systems incorporating games and more particularly, to a performance based marketing and advertising system that incorporates a game. The game incorporates targets bearing unique identification codes placed on people, articles, objects or other such items that may be scanned by a participant who interacts in some manner with a business.

### BACKGROUND OF THE INVENTION

Marketing systems and methods as well as advertising strategies are both ubiquitous and well known. However, because advertising and/or marketing budgets many be limited, some businesses have turned to performance-based advertising and marketing, a marketing method wherein the purchaser pays only when they experience measurable results from the marketing efforts. In the past, businesses typically purchased marketing services or advertising “up front” and usually with little or no way for the business to predict the effectiveness of the marketing or advertising. Performance based marketing methods may eliminate the need for a business to pay up front and certainly eliminate the need for a business to guess what will result from a marketing effort that is not performance based.

Historically, quantifying “measurable results” to a particular business has been problematic. Finding ways to link a potential client of a business with an action by that potential client resulting from a particular advertising or marketing effort is the one shortcoming of many performance-based advertising/marketing systems.

Games have heretofore been used as a part of marketing and advertising methods and systems. One well known games consists of giving a patron a token piece that, when combined with other token pieces in a predetermined configuration, could rewarded the patron with a prize of merchandise or cash.

Further, many interactive games exist wherein one participant scans, tags, or otherwise interacts with a target associated with another game participant. In a target associated with another player such games, the participant doing the tagging or scanning is typically awarded a point or points while the participant being tagged or scanned typically receives nothing. It would, however, be advantageous to award game participants for tagging, for being tagged or for a combination of both.

Well known Laser Tag® (sometimes Laser Tag or Lasertag), the trademark presently owned by Hasbro, is one example of a game wherein a first player pursues and attempts to tag a second player. Typically, only the person achieving the tag wins any points. Laser Tag is typically played by players using infrared projecting “guns” to hit a target on an opponent's body.

### DISCUSSION OF THE RELATED ART

U.S. Pat. No. 8,376,857 issued to Shuman, et al. Feb. 19, 2013 for MULTI-PLAYER ONLINE GAME PLAYER PROXIMITY FEATURE discloses a multi-player online computer game that is played by users involving portable wireless game-playing devices. Each of the portable wireless game-playing devices is located at a respective corresponding physical geolocation. Information that indicates the respective corresponding physical geolocation of each of the portable wireless game playing devices is obtained. This information is used to bring a user of one of the portable wireless game playing devices into physical proximity with other users of portable wireless game playing devices so that a plurality of users of portable wireless game playing devices are participating in the multi-player online game in physical proximity to each other.

U.S. Pat. No. 7,846,028 issued to Small, et al. Dec. 7, 2010 for LAZER TAG ADVANCED discloses Interactive methods and apparatus for infrared (IR) shooting games between PARTICIPANTS. The infrared transmitting and receiving toy has an interface display, switches, and an IR device for transmitting and receiving first or second data between PARTICIPANTS, including tag or hit information and special attack information in response to user actuation of one or more inputs. The information processor generates a hit or tag tally upon receiving first data from IR receiver, and generates an activity upon receiving second data including a video-game or puzzle style activity on the interface display.

Neither of these patents, taken singly, or in combination is seen to teach or suggest the novel Performance Based Marketing System Incorporating a Game of the present invention.

### SUMMARY OF THE INVENTION

In accordance with the present invention there is provided a Performance Based Marketing System Incorporating a Game. The method of marketing provided by the novel system of the invention allows a business to accurately assess the effectivity of their marketing or advertising efforts by using the results of the game play.

Networked smart devices now allow certain interactive games and other interactions suitable for implementing the novel performance based marketing system. In one embodiment, a multi-participant “tagging” game uses PARTICIPANTS each having being uniquely identified. Further, each PARTICIPANT has one or more TARGETS, each having its own unique identification code and being associated with the PARTICIPANT. In summary, each TARGET is associated with a PARTICIPANT and each PARTICIPANT has at least one associated TARGET.

The TARGET unique identification code is typically machine readable. For purposes of disclosure, the ubiquitous Quick Response (QR) code has been used. As used herein in, the term “QR Code” is intended to represent any and all other technologies that may be used to create a machine-readable identification on or in a TARGET. Known alternative identification systems include, but not limited to, optically scanned codes such as bar codes, graphical images, text, etc.); embedded RFID tags readable by an RFID transponder, sonic sensors for decoding acoustical sounds emitted by a TARGET, and electromagnetic receivers for receiving and decoding electromagnetic energy emitter by a TARGET.

TARGETs are typically sold, awarded as promotions or prizes, or gifted, to potential or current game PARTICIPANTs. TARGETS may be removably or permanently placed on or otherwise associated with items such as, but not limited to clothing, hats, footwear, backpacks, vehicles, aprons, key chains, umbrellas, laptop computer cases, cell phone cases, billboards, business cards, other documents, laminated posters, and the like. In addition, businesses using the novel marketing system also may have targets that may be scanned by participants. Business associated TARGETs may, for example, be placed on menus, media advertising pieces, flyers, signs, tickets, wall hangings or any other displays visible to business patrons, or otherwise displayed.

PARTICIPANTs may “SCAN” TARGETS associated with individual PARTICIPANTs or by members of a GROUP, typically businesses, not-for-profit organizations, social organizations, etc. As used herein, the term SCAN is used to represent, in addition to an optical scan of a QR Code, electronically, optically, sonically, radio frequency (RF) receiving, or otherwise reading and decoding a unique identification associated with a TARGET. Scanning is typically accomplished by a mobile device such as a “smartphone”, tablet, or the like. Further, the term SCAN also includes the, manual entry of a code using a keyboard, touchscreen, etc.

GAME rules pertain to all participant SCANs. Businesses may limit the frequency with which a participant may SCAN their targets(s) and/or limit the frequency with which a business employee may scan PARTICIPANT targets. Further, the business may require a “purchase” or other participatory action for the points to be credited to the participant. If, for example, the business is a car dealership, the participant might be required to take a test drive before being awarded the marksman points. Further, the business may establish a maximum distance from the business at which a participant may SCAN a target. Such a case might exist if the business incorporated a target on a document such as a menu or advertising flyer, etc. in the possession of a participant. Businesses may also specify hours of operation (or hours TARGET scans are allowed). Furthermore, a participating business completely defines the interactions with the game operator. For example, the participating business specifies the points awarded and corresponding cost the daily budget, times between allowed scans, etc. Such details are discussed in detail hereinbelow. The flexibility of the game allows each participating businesses to create individualized operating “rules”. Such rules are setup or changed in the business configuration portion of the game software as discussed in great detail hereinbelow. SCANs of business-“owned” targets give the business an accurate metric of the effectiveness of their marketing efforts using results of the game.

A tally is automatically kept by the system operator of both MARKSMAN and MARK points and the ranked standing of PARTICIPANTS may be maintained. MARKSMAN and MARK points as well as standings may be made available on a website maintained by the game operator. Many other type of tallies may be defined and maintained. In one example, MARKSMAN and MARK ranks may be maintained for PARTICIPANTs who scanned and were scanned by a particular BUSINESS PARTICIPANT. It will be recognized that many other specific tallies may be defined and kept.

Games typically have fixed durations and prizes are typically awarded at the conclusion of a game to both participants having the highest number or MARKSMAN point as well as the participant having the highest number of MARK points. Such prizes may be cash, merchandise, gift cards, coupons, or other such items. Prizes are typically funded by the sale or re-registration of targets, ad fees generated by scans of business targets, and other potential sources of revenue possible from the game. For example, website business target locations can provide links to the website associated with a business target. Accessing websites by such links may generate additional ad revenue. It will be recognized that many other algorithms may be used to award cash or other prizes to other PARTICIPANTS at the conclusion of a game.

It would, therefore, be advantageous to provide a performance based marketing/advertising system incorporating a multi-PARTICIPANT game.

It would be further advantages to provide a performance based marketing/advertising system incorporating a multi-PARTICIPANT game wherein each PARTICIPANT has at least one TARGET that may be scanned by other PARTICIPANTs.

It would be additionally advantages to provide a performance based marketing/advertising system incorporating a multi-PARTICIPANT game wherein a BUSINESS PARTICIPANT may have one or more TARGETS that may be scanned by a PARTICIPANT.

It would be still further advantages to provide a performance based marketing/advertising system incorporating a multi-PARTICIPANT game wherein BUSINESS PARTICIPANT TARGETS may have unique attributes such as validation criteria, unique algorithms for rewarding points to PARTICIPANTS, scan periods and/or frequencies, and unique algorithms for calculating fees charged to a BUSINESS PARTICIPANT.

It would be still further advantages to provide a performance based marketing/advertising system incorporating a multi-PARTICIPANT game wherein BUSINESS PARTICIPANT TARGETS may be assigned to a GROUP having common attributes such as validation criteria, unique algorithms for rewarding points to PARTICIPANTS, scan periods and/or frequencies, and unique algorithms for calculating fees charged to a BUSINESS PARTICIPANT.

It would be further advantages to provide a performance based marketing/advertising system incorporating a multi-PARTICIPANT game wherein a set of rules determine play of the game and an algorithm for awarding points to participants as well as awarding prizes at the conclusion of a game.

It would be additionally advantageous to provide a capability for SUB GAMES wherein PARTICIPANTS and/or BUSINESS PARTICIPANTS may define and configure a SUB GAME.

### BRIEF DESCRIPTION OF THE DRAWINGS

Various objects, features, and attendant advantages of the present invention will become more fully appreciated as the same becomes better understood when considered in conjunction with the accompanying figures, in which like reference characters designate the same or similar parts throughout the several views, and wherein:

FIG. 1 is greatly simplified, schematic system diagram showing an environment supporting the operation of the performance based marketing system incorporating a game in accordance with the invention;

FIG. 2A is a screen shot of a typical Home screen including MARK and MARKSMAN standings of the game forming a part of the invention;

FIG. 2B is a screen shot of a typical Map screen;

FIG. 2C is a screen shot of a typical map screen showing particular business details of an exemplary business;

FIG. 2D is a screen shot of a typical map screen where details of a second business are displayed;

FIG. 2E is a screen shot of a typical information menu;

FIG. 2F is a screen shot of a typical getting started information screen;

FIG. 2G is a screen shot of a typical scoring points information screen;

FIG. 2H is a screen shot of a typical game history information screen;

FIG. 2I is a screen shot of a typical Question and Answer (Q&A) information screen;

FIG. 2J is a screen shot of a typical Business meeting request form screen;

FIG. 2K is a screen shot of a typical login screen;

FIG. 2L is a screen shot a typical shop links screen;

FIG. 2M is a screen shot of a typical ecommerce storefront screen;

FIGS. 2N1 and 2N2 are screen shots of typical ecommerce product screens;

FIG. 2O is a screen shot of a typical ecommerce shopping cart screen;

FIGS. 2P1, 2P2, and 2P3 are screen shots of three pages of a typical ecommerce checkout operation;

FIG. 2Q is a screen shot of a typical Create New Account screen of the game forming a part of the invention;

FIG. 2R is a screen shot of a typical Welcome Participant screen of the game forming a part of the invention;

FIG. 2S is a screen shot of a typical Manage Targets screen of the game forming a part of the invention;

FIG. 2T is a screen shot of a typical Manage Participant Information screen of the game forming a part of the invention;

FIGS. 2U, 2V, and 2W are screen shots of typical Select Reports screens of the game forming a part of the invention;

FIG. 2X is a screen shot of a typical Agreements screen of the game forming a part of the invention;

FIG. 2Y is a screen shot of a typical Terms of Service Agreement screen of the game forming a part of the invention;

FIG. 2Z is a screen shot of a typical Rules and Gameplay screen of the game forming a part of the invention;

FIG. 3A is a screen shot of a typical Manage Groups/Locations home screen;

FIGS. 3B and 3C are screen shots of a first and second portion of a Manage Groups/Locations data entry or edit screen; and

FIG. 4 is a greatly simplified of a flow chart of one aspect of playing the game forming a part of the invention.

### DETAILED DESCRIPTION OF THE PREFERRED EMBODIMENT

### Glossary

For purposes of the description provided hereinbelow, it is most helpful to know the following terms and the definitions assigned and used by Applicant:

### Business Participant

A PARTICIPANT using the game system to promote products and/or services to other PARTICIPANTS.

### Fixed Target

A TARGET not necessarily associated with a PARTICIPANT account but which produces MARK and/or MARKSMAN points when SCANNED by a PARTICIPANT.

### Game

A period of time during which PARTICIPANTs can accumulate MARKSMAN and MARK points by scanning each other (typically only once) and by visiting businesses and scanning business TARGETS and be scanned by the business. At the end of each GAME, points are tallied and prizes awarded. Tag and be tagged; enabled by physical TARGETS, means for capturing information embedded in the physical TARGETS, means for communicating, via the Internet for storing and querying data and reporting the queried data in a database-driven website.

### Game Administrator

The person or persons given authority to manage the GAME by the GAME OPERATOR.

### Game Operator

The business entity is responsible for providing the website, providing game rules, and overseeing game play. The GAME OPERATOR is responsible for contracting with business for sponsorship and/or advertising.

### Group

A subset of GAME PARTICIPANT TARGETS associated with a common set of attributes. For example, a GROUP can be defined for a business, for example, a dining establishment. All PARTICIPANT TARGETS associated with the GROUP (e.g., waiters and/or bartenders) typically have a common location for proximity validation, a common budget, and can have weighted MARK and/or MARKSMAN values (i.e., points assigned to the patron MARKSMAN) and other or the same weighted SCAN values (points assigned to the patron MARK). In the case where a participating business has multiple locations, each location is assigned its own GROUP. The GROUP can embody means for conducting surveys, for example, or advertisements such as discount coupons. Such GROUPS can be SCANNED periodically, such as daily. Multiple GROUPs for a business allows different GAME configurations for each location as well as allowing generating individual REPORTS for each location.

### Mark

A PARTICIPANT being SCANNED by another PARTICIPANT's TOOL.

### Marksman

PARTICIPANT performing the SCAN of another PARTICIPANT's TARGET.

### Participant

A person or entity active in a game, especially a person who has created and submitted information to establish an account registering/assigning at least one TARGET.

### Prize

An item or number of items having value and awarded, typically at the conclusion of a GAME, to PARTICIPANTS upon achieving certain reward point goals.

### Scan

The act of a PARTICIPANT using his/her TOOL (e.g., s smart phone, etc.) to record another PARTICIPANT's TARGET or embedded information. Subsequently, the TARGET (and/or embedded information) as well as information identifying the PARTICIPANT performing the SCAN is submitted to the GAME server.

### Seed

A unique form of TARGET planted in strategic locations to initiate the GAME. Implementation of SEED TARGETS may or may not be the same as standard TARGETS. For example, a SEED TARGET can be created by the GAME administrators and associated with locational information such as a poster at Grand Central Station in New York City.

### Sponsor

An entity, typically a business that participates in the GAME and purchases marketing and/or advertising services from the GAME OPERATOR. A SPONSOR may also provide prizes awarded to PARTICIPANTs during or at the conclusion of a GAME.

### Subgame

Managed by an organization or PARTICIPANT. A PARTICIPANT can be associated with any number of SUBGAMES. SUBGAMES provide a method for a subset of GAME PARTICIPANTS or PARTICIPANT TARGETS to compete against each other. SUBGAMES can be configured to present PARTICIPANTS with customized messages (e.g., upon game initialization, completion, milestones, TARGET SCANS, etc.). Some sample SUBGAME themes are “treasure hunt” and “commando.” The start and end dates of a SUBGAME coincide with the start and end dates of the GAME with which the SUBGAME is associated.

### Target

Items with unique identifiers sold or provided as promotional items to PARTICIPANTS. For example: T-shirts with a QR code printed on the back thereof can be TARGETS. The TARGET can be embedded with a URL or unique IP address. One or more TARGETS are associated with each PARTICIPANT.

### Tool

Smart device or computer capable of executing program steps and used by PARTICIPANTS to REGISTER and SCAN TARGETS. For purposes of this description, the word, “phone” is intended to include any so-called smart communication device. The TOOL may store SCANNED TARGETS in a SCAN queue and periodically downloads the SCAN queue to the GAME server. The program steps can be managed by a browser viewing the GAME website or an application (i.e., an “App”) communicating with the GAME server. The TOOL may also record and download information to direct the system to access information including but not limited to: Date and time when each SCAN occurred; Location of the TOOL when each SCAN occurred; TARGET unique identifier; and PARTICIPANT GAME account information.

### User

A person who uses or operates a computer or smart device.

In accordance with the present invention there is provided a system and method implementing a Performance Based Marketing and Advertising System Incorporating a Game. The novel method allows a marketer/advertiser to pay for advertising or marketing services only when a measurable result attributable to the advertising or marketing services results therefrom. The “measurable results” is supported by data from the game(s). Typically, a business may be given great control over GAME parameters such as daily budget, weekly or monthly budget, requirement for a purchase or other activity before points are awarded, geographic location, frequency of scans permitted for each unique TARGET proximity to a specific business address before points are awarded, the points awarded and associated advertising cost, etc.

The game forming a portion of the marketing/advertising system of the invention is a game wherein two or more PARTICIPANTS each acquire and register a TARGET that includes a unique identification code. Typically the TARGET's unique identification code is machine readable. Each TARGET is registered to and associated with a single PARTICIPANT or with a member of a GROUP. PARTICIPANTs may SCAN (i.e., read) the other PARTICIPANTs TARGET(s) and communicate the result of the TARGET SCAN to software (e.g., the website) monitoring the play of the GAME. Rules determine the number of SCANS that PARTICIPANTs may make of other PARTICIPANTs during the duration of a GAME that has fixed start and end dates and times. Points are awarded to PARTICIPANTs who SCAN other PARTICIPANTs (i.e., “MARKSMAN” points) and to the scanned PARTICIPANTs (i.e., “MARK” points). Prizes may be awarded to one or more PARTICIPANTs based on MARKSMAN points rankings as well as to the PARTICIPANT based on MARK point rankings at the conclusion of a GAME.

GAMEs may operate with or without BUSINESS PARTICIPANTS. In addition BUSINESS PARTICIPANTS may be added, or deleted at any point during the GAME.

As used hereinafter, the term “his” is intended to be gender neutral and to refer to a person either male or female.

For purposes of disclosure, a game “Tag-and-be-Tagged”, described in more detail hereinbelow, is used. Hereinafter “Tag and Be Tagged” is referred to as “the game.”

The game is operated by a game operator. For purposes of disclosure, the game operator is tageandbetagged.com and exemplified by a website at that URL. For simplicity, the “tagandbetagged.com” website is hereinafter referred to as “the website.”

Several objects are identified in the play of a game. These include but are not limited to:

TARGETS each having a unique identification, preferably machine readable; PARTICIPANTS each having a unique identification code; GROUPS; and GAMES.

Each of these objects typically has an associated table storing information relating to their respective objects. These tables collectively form of a relational database. Specific data structures, table field names, and relationships among the tables are discussed in more detail hereinbelow. As an illustrative example, a representation of a typical table associated with the TARGETS object is provided.

TABLE I
Targets

| Field Name | Field Type | Field Attribute |
|---|---|---|
| Index | Big Integer | 8, Unsigned |
| Primary | Tiny Integer/Boolean | 1 |
| Gift | Tiny Integer/Boolean | 1 |
| Gift Tally | Tiny Integer | 3 |
| Participant Index | Big Integer | 8, unsigned |
| Group Index | Big Integer | 11, Unsigned |
| Unique Target ID | Var. character | 8 |

Table I shows a representation of Field Names, Field Types, and Field Attributes. The Field Types and Field Attributes are believed to be well known concepts to persons of skill in the programming arts and therefore, not discussed in more detail herein. These or similar tables and/or fields may hold temporary information primarily about purchased, activated TARGETS.

TARGETS are the single most important object in the game. As mentioned hereinabove, TARGETS are preferably machine readable may be removably or permanently placed on items such as, but not limited to clothing, hats, footwear, backpacks, vehicles, aprons, key chains, umbrellas, laptop computer cases, cell phone cases, billboards, business cards, other documents, laminated posters, and the like. TARGETS may be sold, provided as promotional items, or otherwise distributed to PARTICIPANTS and potential PARTICIPANTS. Purchased TARGETS can be associated with PARTICIPANTS accounts during a fulfillment process but typically are associated when added to an account. Gifting TARGETS may require PARTICIPANT account creation and/or association with an existing PARTICIPANT account. As discussed in more detail hereinbelow, gift MARKSMAN points can be scored by purchasing one or more TARGETS and adding the TARGETS to an account, marking one or more TARGETS as gifts, and providing gifted TARGETS to someone who eventually becomes a PARTICIPANT (i.e., adds the TARGETS to a new account. Promotional MARK points can be scored by wearing or displaying a TARGET and being SCANNED by a person who is or who eventually becomes a PARTICIPANT (i.e., creates a new account and adds a TARGET.

A key field in TABLE I is the Participant Index that is used to associate the TARGET and its unique Target ID to a particular PARTICIPANT.

The Participant Table contains demographic information for each PARTICIPANT and a representation of a typical Participant table is shown in Table II.

TABLE II
Participants

| Field Name | Field Type | Field Attribute |
|---|---|---|
| Index | Big Integer | 8, Unsigned |
| User ID | Var. Character | 16 |
| Password | Var. Character | 16 |
| Password Change Code | Var. Character | 10 |
| defaultGroupTypeindex | Big Integer | 8, Unsigned |
| Session ID | Var. Character | 128 |
| Session Start | Timestamp | |
| Session Security Code | Var. Character | 10 |
| Address First Name | Var. Charter | 50 |
| Address Last Name | Var. Charter | 50 |
| Address - Email | Var. Charter | 50 |
| Address - Email Verification | Var. Charter | 50 |
| Address - Comp | Var. Character | 50 |
| Address - Phone | Var. Character | 50 |
| Address - Fax | Var. Character | 50 |
| Address - Addr | Var. Character | 50 |
| Address - Addr2 | Var. Character | 50 |
| Address - City | Var. Character | 50 |
| Address - State | Var. Character | 50 |
| Address - Zip | Var. Character | 50 |
| Address - Country | Var. Character | 50 |

The Game Table associated with the GAMES object contains many of the parameters that govern the play of the game.

A representation of a typical Game Table is shown in Table III.

TABLE III
Game

| Field Name | Field Type | Field Attribute |
|---|---|---|
| Index | Big Integer | 8, Unsigned |
| Title | Var. Character | 50 |
| Game Start | Timestamp | |
| Game End | Timestamp | |
| Start Target Activation | Timestamp | |
| End Target Activation | Timestamp | |
| Start TARGET Gifting | Decimal | 11, 2 |
| End TARGET Gifting | Decimal | 11, 2 |
| Prize Cash Base | Decimal | 11, 2 |
| Prize Cash per Target | Decimal | 11, 2 |

The Game Table contains data that controls the overall aspects of the game. The start date and time and the end date and time are believed to be self-explanatory. TARGETS are typically active only for a single game. TARGETS must be active for a particular GAME to score points and win prizes. A TARGET is initially activated upon purchase or upon association with an account. Near or at the end of a game, if the TARGET is to be used in a subsequent game, it must be reactivated. Reactivation may be done at any time during a game. Typically, reactivation of a TARGET requires payment of a reactivation fee. MARK and/or MARKSMAN points may be earned by purchasing a TARGET and/or designating a TARGET as a TARGET to be gifted (i.e., providing the TARGET to another person who then adds the TARGET to a new ACCOUNT. To help provide some degree of fairness, TARGETS for specific game may be activated during a time period defined by the Start Target Activation and the End Target Activation dates/time. It will be recognized that similar control on the gifting of TARGETS may be desirable. If the Start Target Activation date/time falls before the previous game End Target Activation date/time (i.e., time periods overlap), TARGETS activated during such overlap time will be active for both games.

Cash prize values are generated by such factors as the prize cash base plus number of TARGETS in play in the games multiplied by prize cash per TARGET. Prize cash base prize cash per target are also stored in the Game Table. The foregoing describes typical prize valuation and awarding strategies. It will be recognized that many alternate prize valuation and/or prize awarding strategies are possible and the invention is not intended to be limited by the strategies chosen for purposes of disclosure. Rather, the invention is intended to include any and all possible prize valuation and awarding strategies.

A GROUP consists of one or more TARGETS with something in common. A GROUP may also be thought of as a location. For example, a restaurant can form a GROUP that includes all of its employees TARGETS. Each GROUP may be configured such that a patron of, for example, the restaurant, (MARKSMAN) may be credited extra points for SCANNING a restaurant employee (MARK) and/or a patron (MARK) is credited extra points for being SCANNED by an employee (MARKSMAN). Similarly, a GROUP may consist of celebrities or professional sports figures or local, state, or national politicians. Similarly, GROUPs may be organizations that use the Tag and Be Tagged game for fundraising. The GROUP object is used primarily, but not exclusively, to contain data pertaining to sponsors (i.e., businesses) involved in the game. A representation of a typical Group Table is shown in TABLE IV.

TABLE IV

| Field Name | Field Type | Field Attribute |
|---|---|---|
| Index | Big Integer | 8, Unsigned |
| Group Type Index | Big Integer | 8, Unsigned |
| Group Owner/Location | Big Integer | 8, Unsigned |
| Name | Character | 32 |
| Active | Tiny Integer | 1 |
| Daily Budget | Decimal | 10, 2 |
| Advertisement | Character | 256 |
| Latitude | Floating | 10, 6 |
| Longitude | Floating | 10, 6 |
| Group Type Rate Mark Index * | Big Integer | 8 |
| Group Type Rate Marksman Index * | Big Integer | 8 |
| Mark Group Type Frequency Index * | Big Integer | 8 |
| Marksman Group Type Frequency Index * | Big Integer | 8 |
| Mark Purchase Required * | Tiny Integer | 1 |
| Marksman Purchase Required * | Tiny Integer | 1 |

Note:
fields marked “*” may in a separate table to allow each TARGET associated with the GROUP to award different point values.

The use for the information in each of these fields will become clear as the play of the game is later described in detail.

As mentioned, the tables associated with the TARGET, PARTICIPANT, GAME, and GROUP objects form a portion of a relational database. That database housed on a server under the control of the game operator. The server supports the website and is used to manage all aspects of the tag and be tagged game.

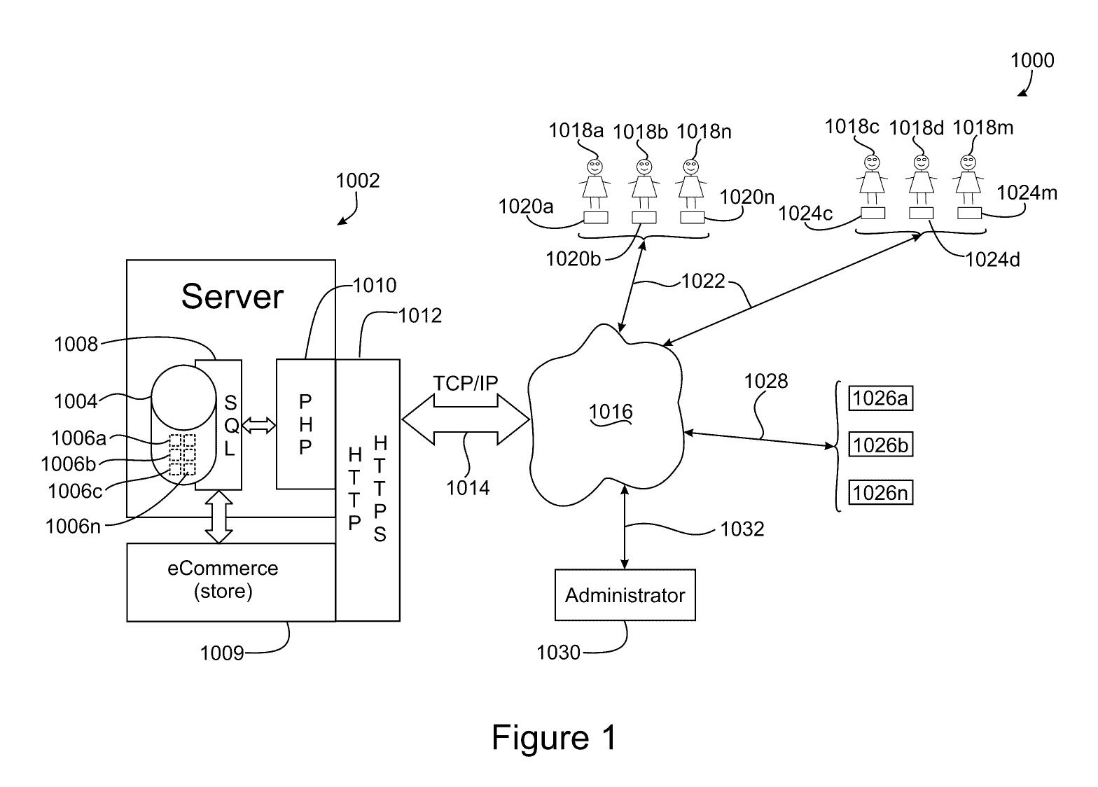

Referring first to FIG. 1, there is shown a simplified block diagram of the system that supports the website and all other computer related aspects of the game, generally at reference number 1000.

A server system 1002 consists of relational database(s) 1004. Relational database 1004 contains tables shown schematically at reference numbers 1006a, 1006b . . . 1006n. In the embodiment chosen for purposes of disclosure, Structures Query Language (SQL) using SQL interface 1008 for interaction with (i.e., querying) the relational database 1004.

A Hypertext Pre-processor (PHP) is a server-side scripting language designed for web development but also used as a general-purpose programming language. A PHP Hypertext Preprocessor 1010 are included within server 1002.

An ecommerce subsystem 1009 provides a storefront where PARTICIPANTs and potential PARTICIPANTs may purchase and/or reactivate TARGETs.

Hypertext Transfer Protocol (HTTP) is the set of rules for transferring files (text, graphic images, sound, video, and other multimedia files) on the World Wide Web. A HTTP/HTTPS sub-system 1012 forms a server side interface for server 1002. HTTPS is a secure version of HTTP, typically implemented using a Secure Sockets Layer (SSL).

Communications between server 1002 and the Internet (World-Wide Web) 1016 is typically accomplished with a TCP/IP link 1014. TCP/IP (Transmission Control Protocol/Internet Protocol) is the basic communication language or protocol of the Internet 1016.

It will be recognized by those of skill in the art that many additional components may be required to form a functional computer/server system 1002 and client browsers. However, for purposes of simplicity, none are shown but are assumed to exist and to be present in server 1002. It will be further recognized that well-known and commonly uses communications protocols and devices have been shown for purposes of disclosure. However, alternate protocols and/or devices are also believed to be known or may be invented and developed in the futures that me be suitable replacements for the protocols and/or devices chosen for purposes of disclosure. Consequently, the invention is not considered limited to any specific communications protocol and/or device(s). Rather, the invention is intended to include any and all suitable replacements for the protocols and/or devices chosen for purposes of disclosure.

Participants 1018a, 1018b . . . 1018n are equipped with an electronic communications device 1020a, 1020b . . . 1020n (e.g., cellular telephone, tablet, smart watch, notebook computer, desktop computer), respectively. It will be recognized that a portable device may be advantageous for playing the GAME. Each electronic communications device 1020a, 1020b . . . 1020n is equipped with a browser through which all communications with server 1002 is managed.

Participants 1018c, 1018d . . . 1018m are also equipped with electronic communications devices 1024c, 1024d . . . 1024m having an operating system, not shown, running a dedicated application through which all communication with server 1002 is managed. Like devices 1020a, 1020b . . . 1020n, devices 1024c, 1024d . . . 1024m may advantageously be portable devices.

Both groups of participants 1018a, 1018b . . . 1018n and 1018c, 1018d . . . 1018m are connected to server 1002 by TCP/IP links 1022 via Internet 1016.

Sponsors 1026a, 1026b . . . 1026n are connected to server 1002 by TCP/IP link 1028. Each sponsor 1026a, 1026b . . . 1026n preferably has at least one electronic communications device, none shown, for allowing communication with server 1002. Both configuration and game play (i.e. more specifically scanning TARGETS) is performed using a browser or “app” on a computer or smart device. Sponsor may rely on the game operator to configure their Group(s)/Location(s.

A Game Administrator 1030 is connected to server 1002 by TCP/IP link 1032 via Internet 1016.

All play and administration of the game in accordance with the invention is accomplished at the game operator website.

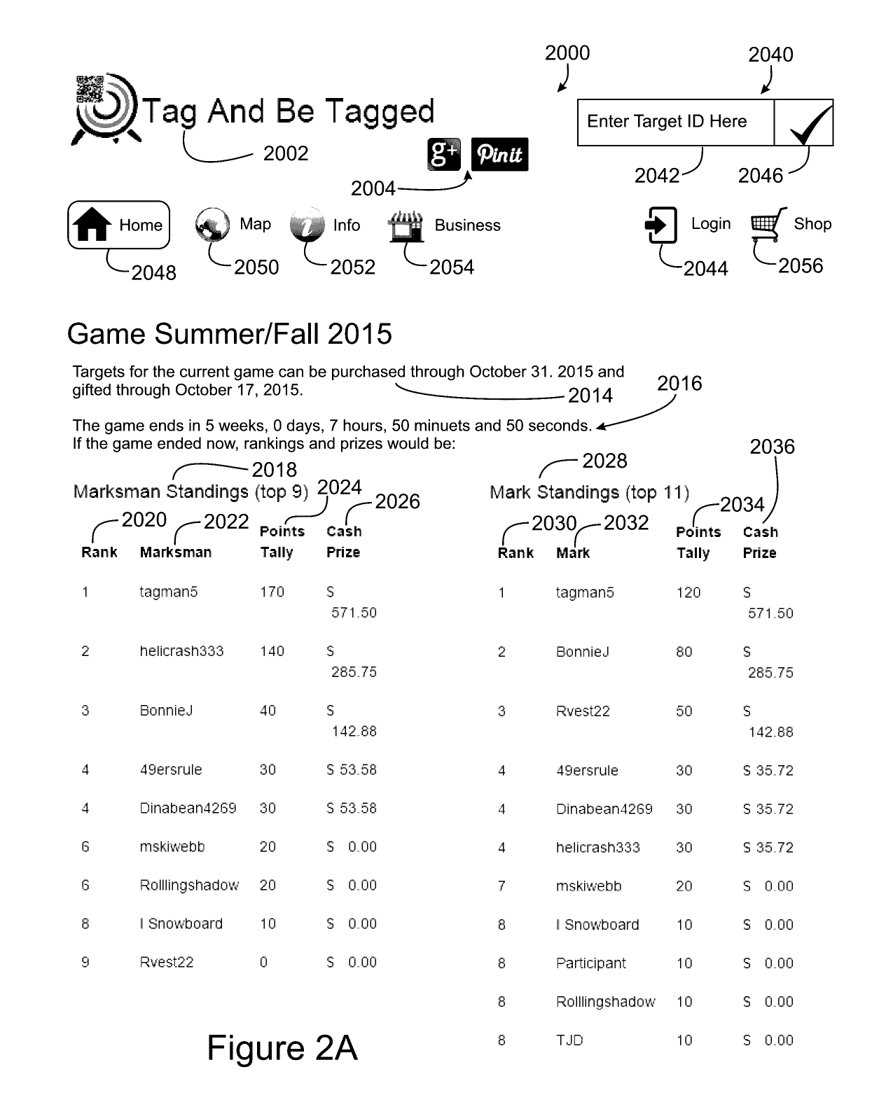

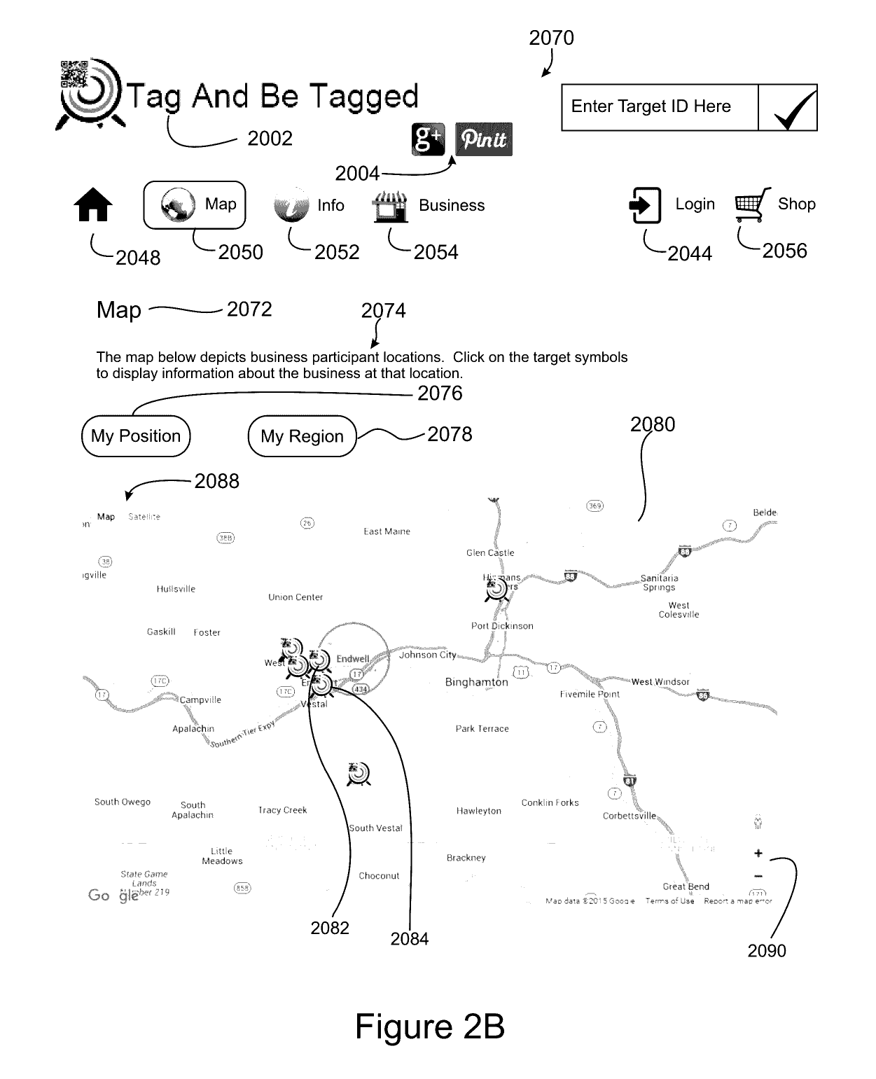

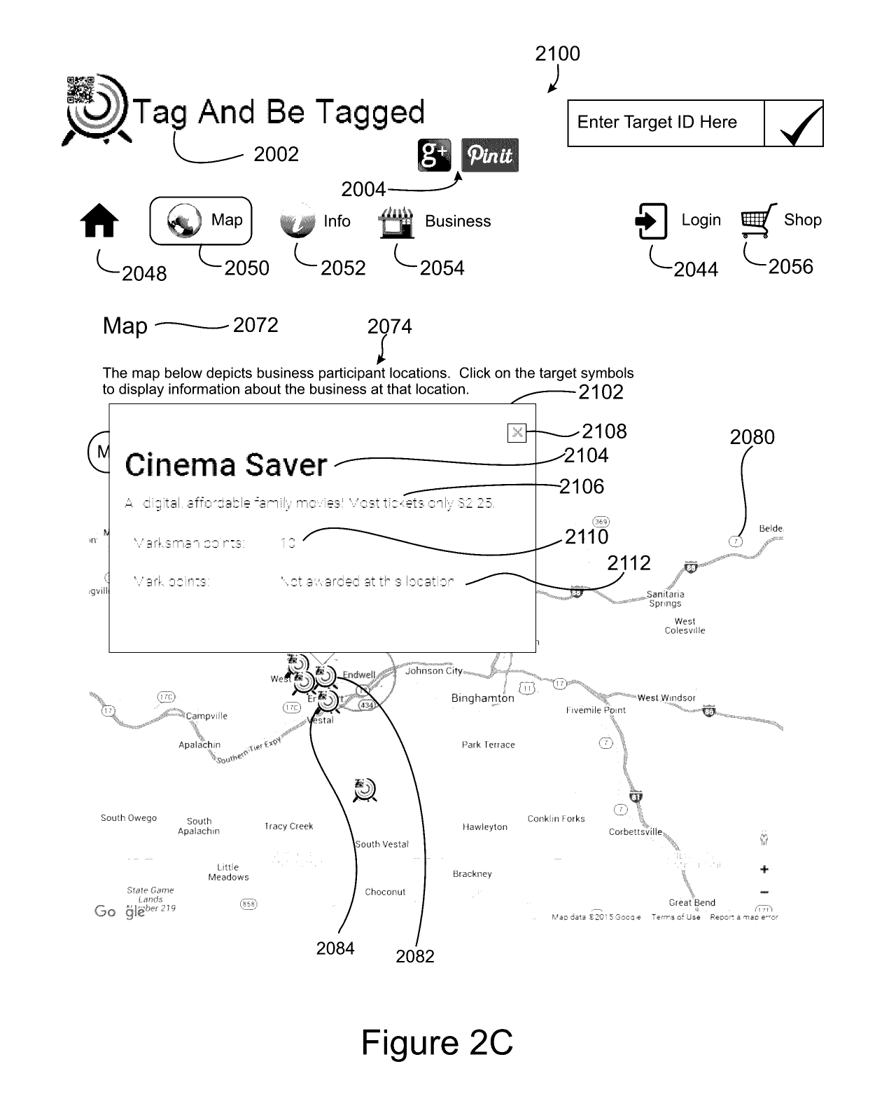

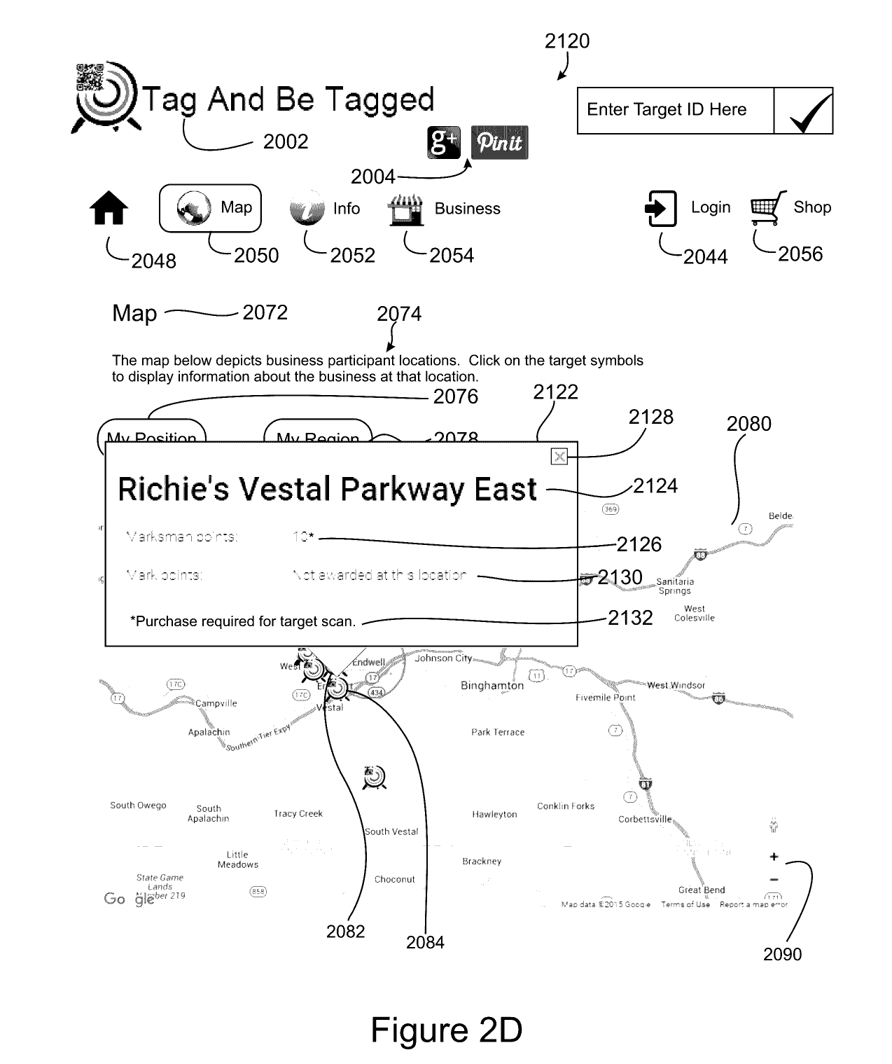

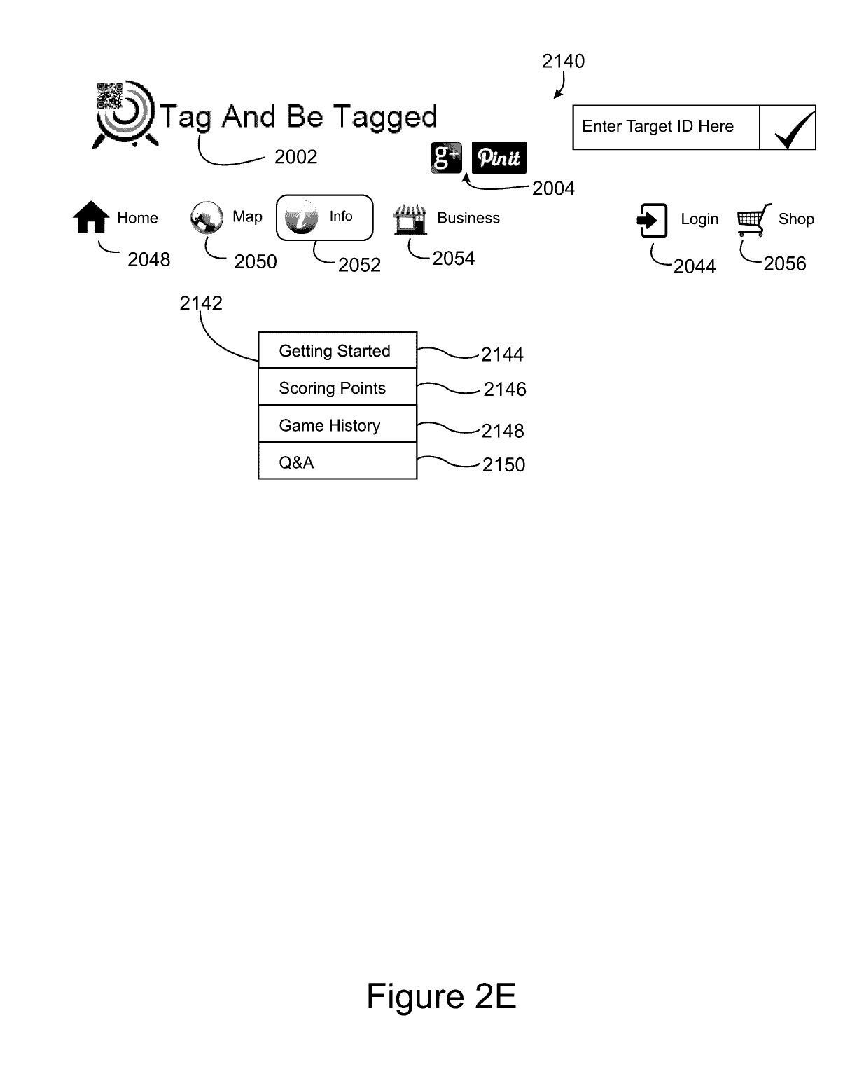

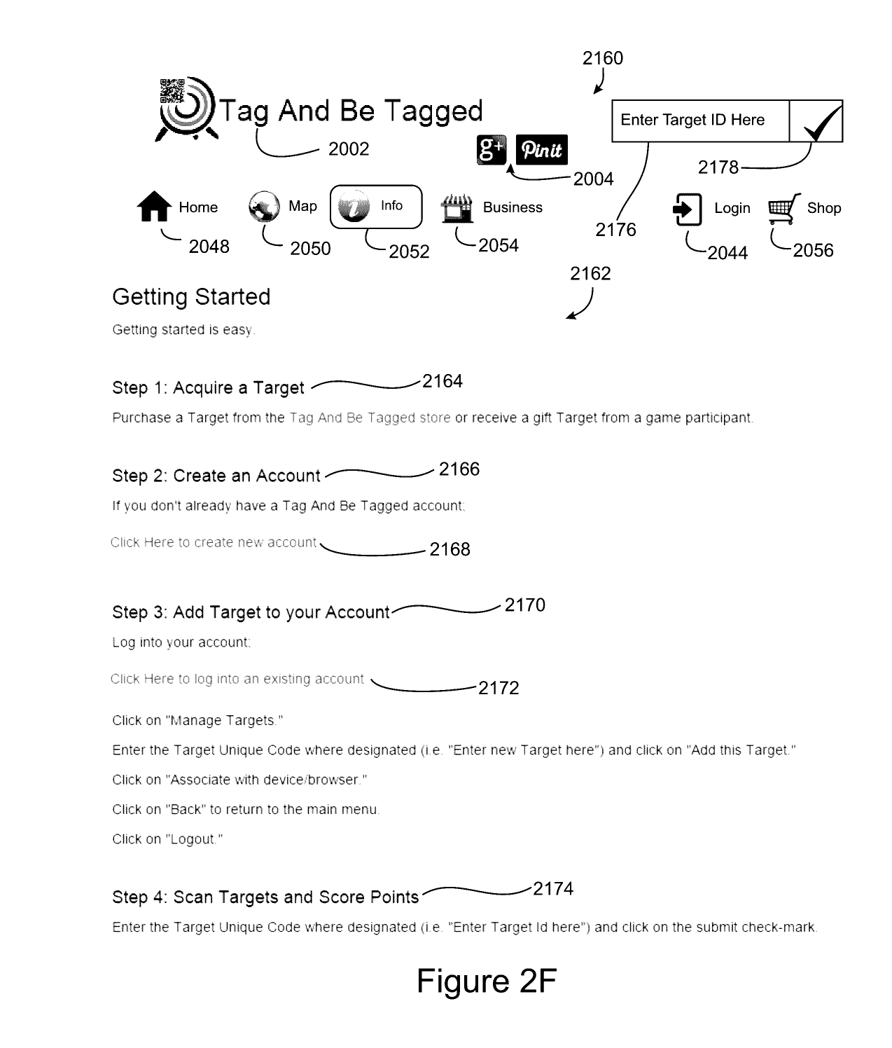

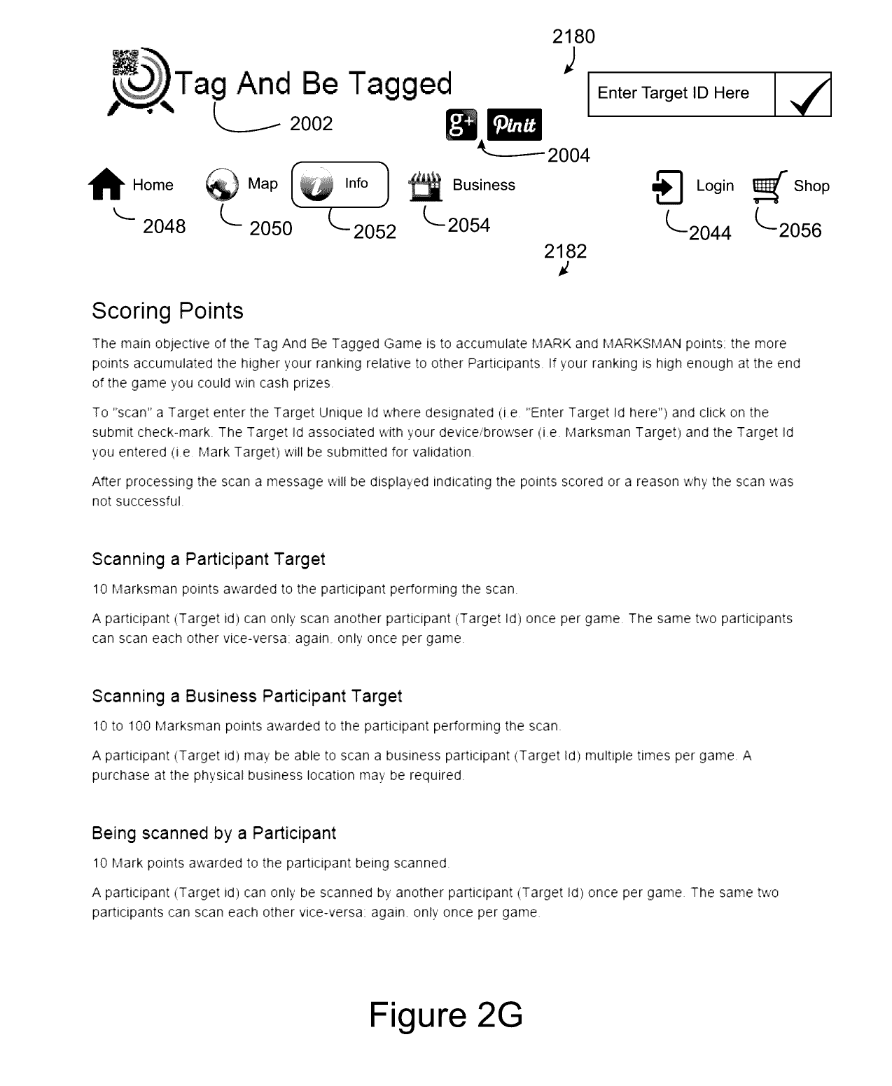

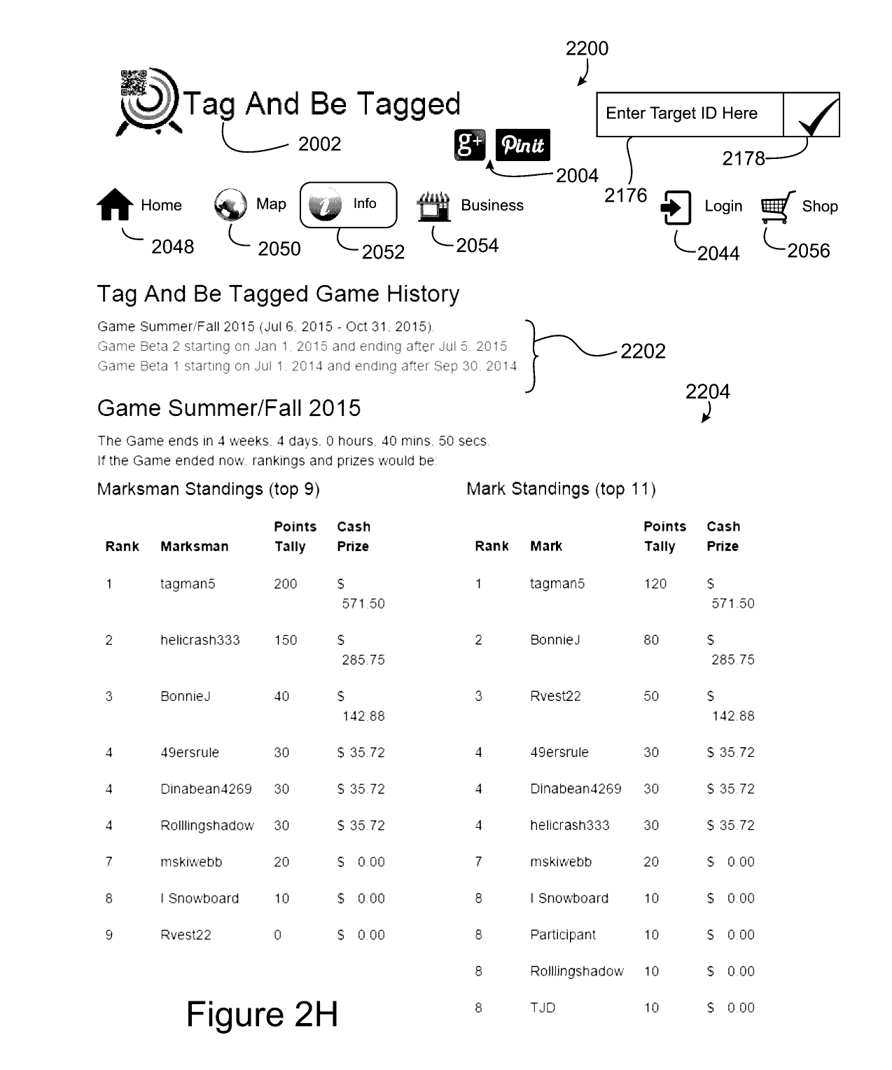

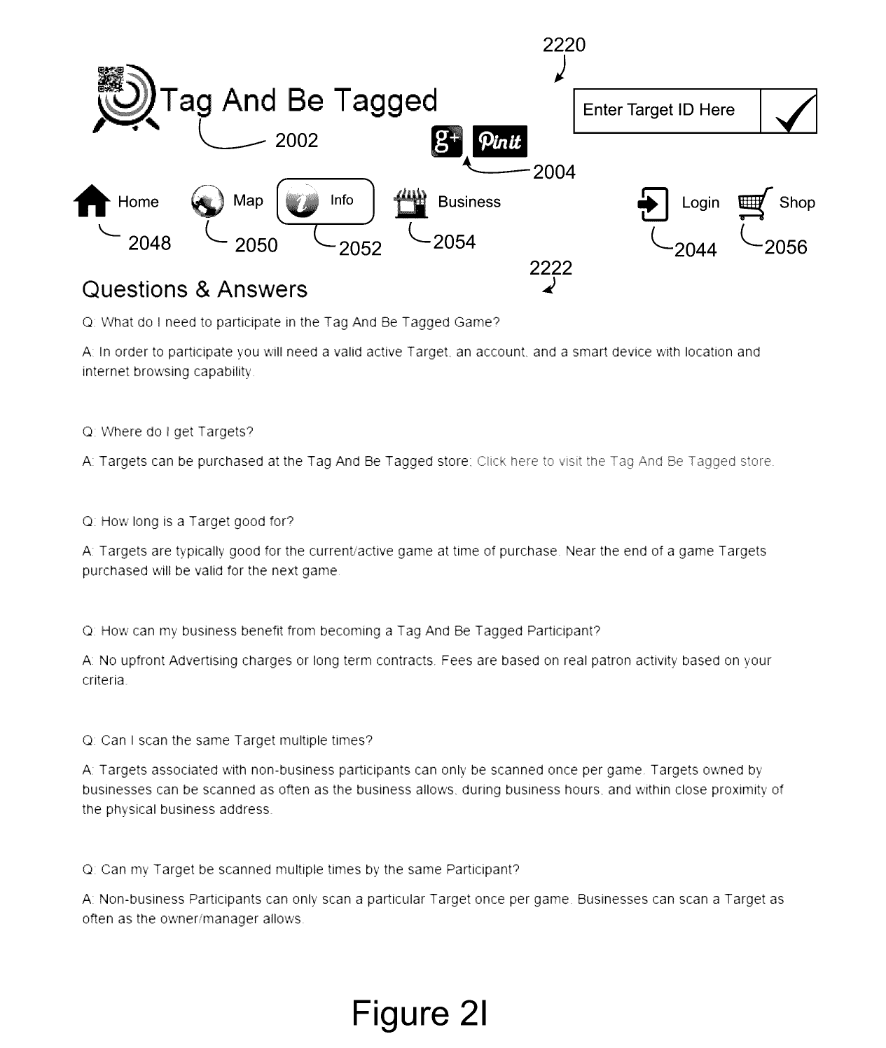

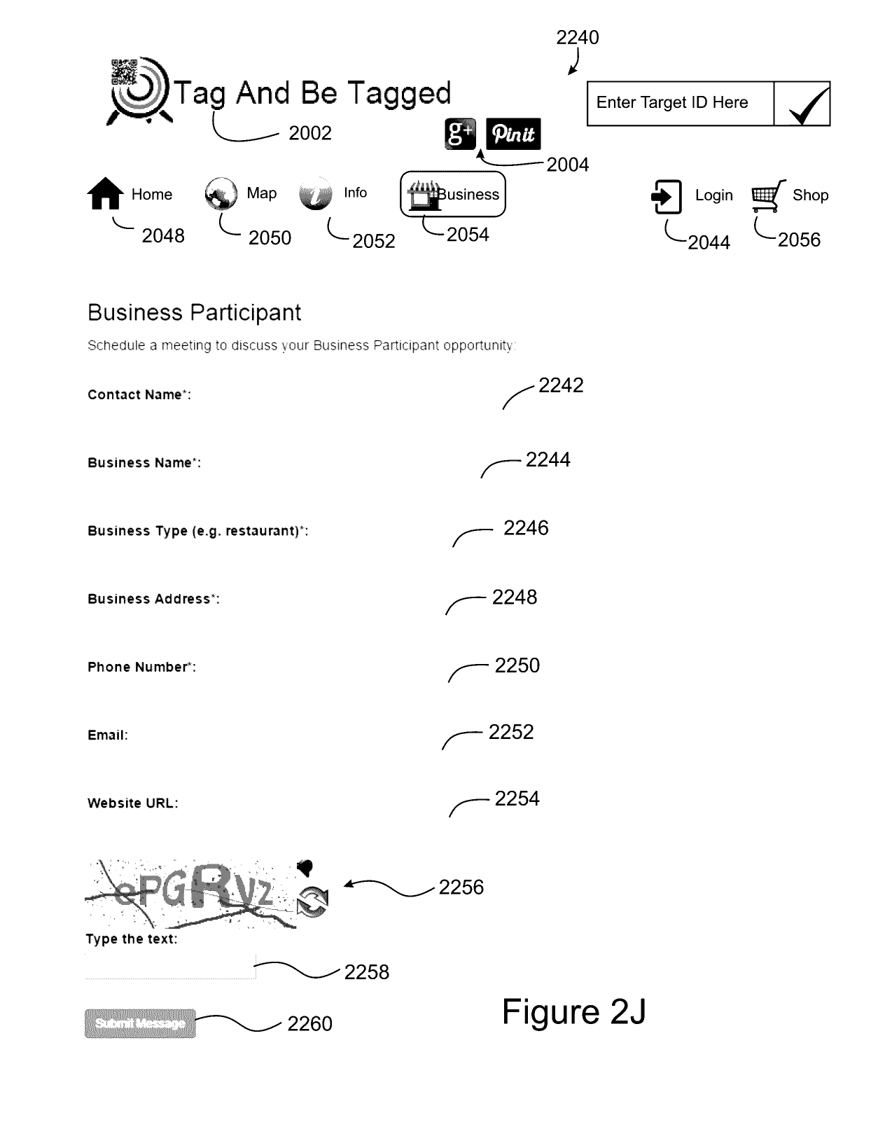

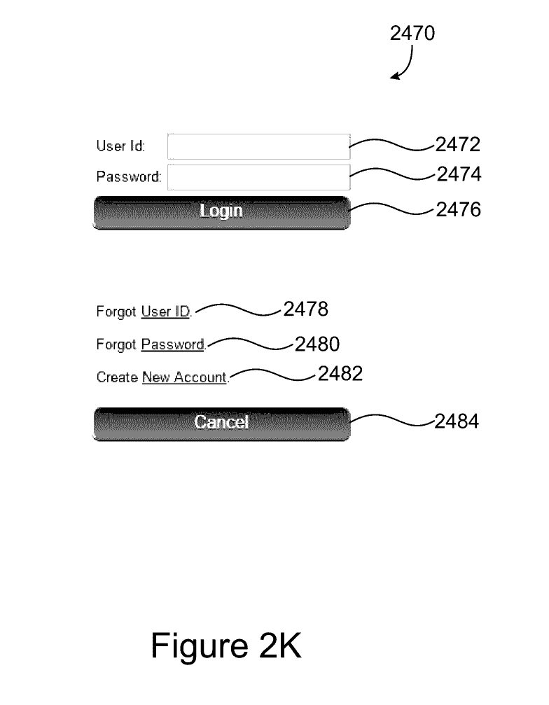

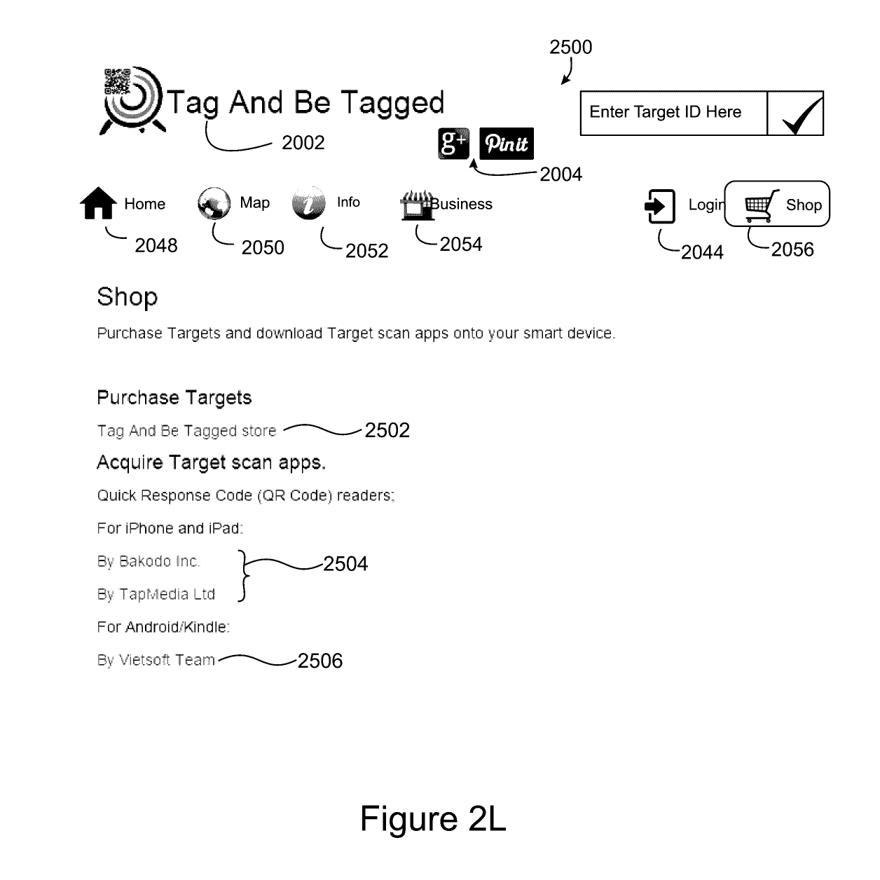

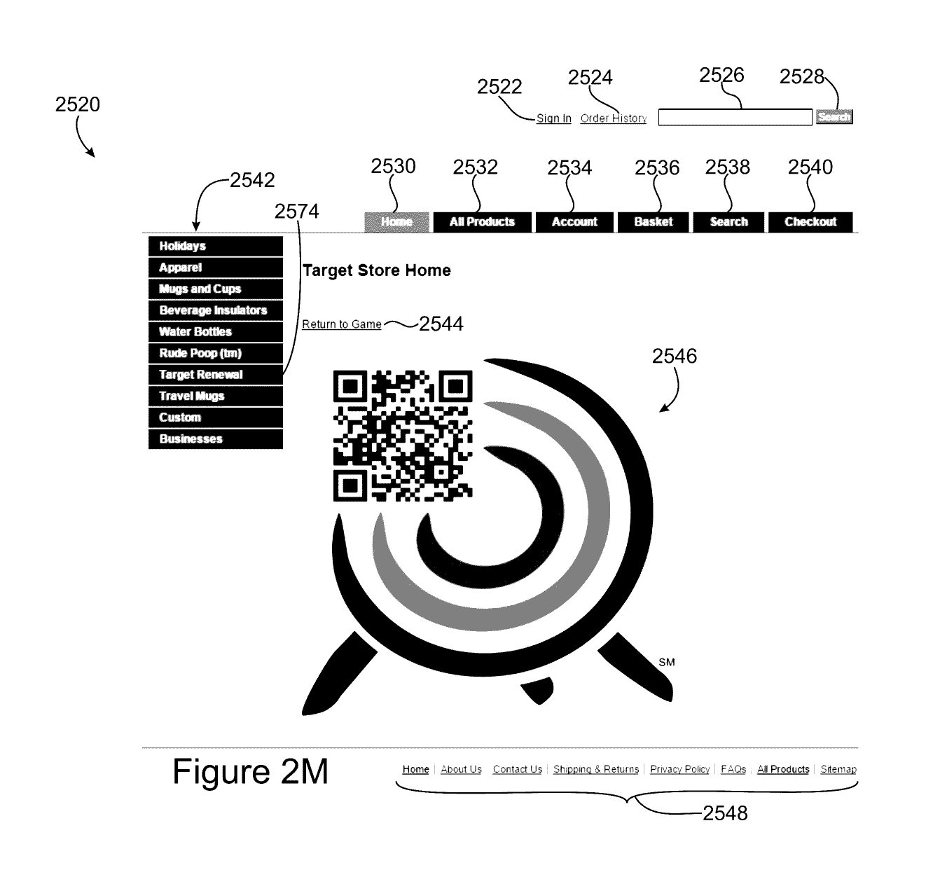

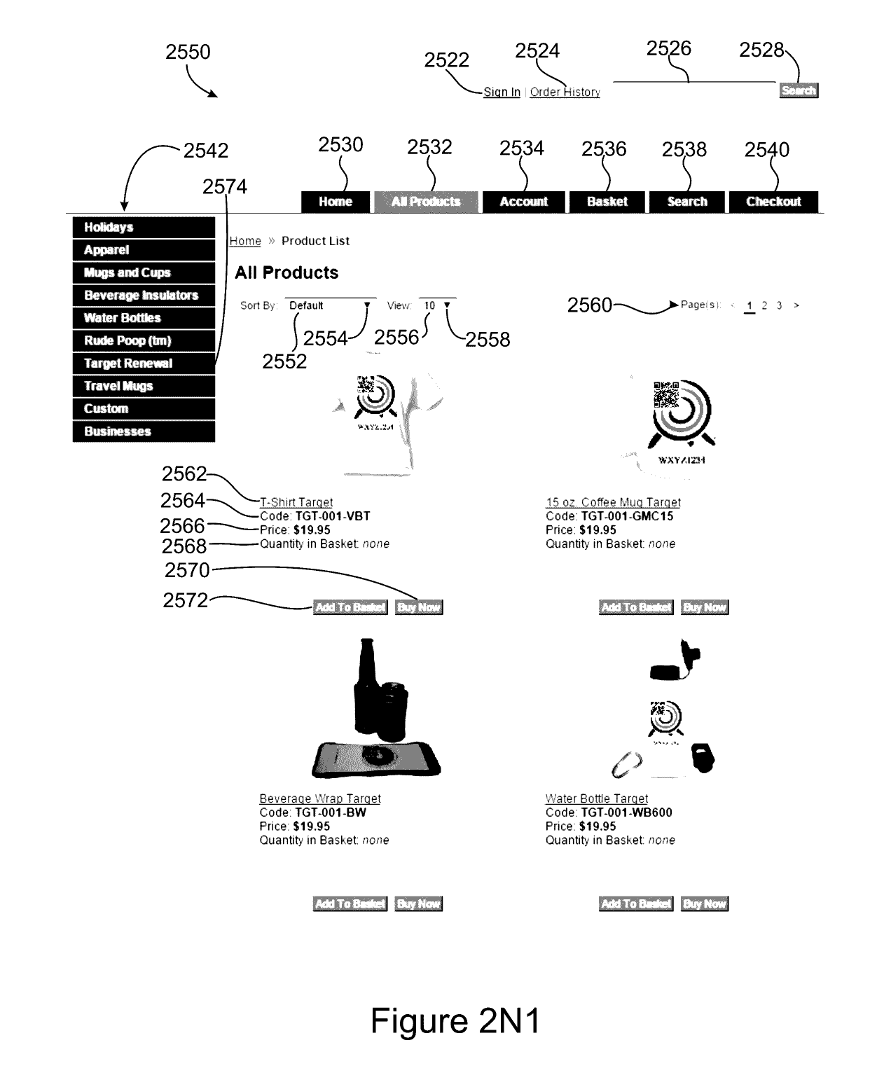

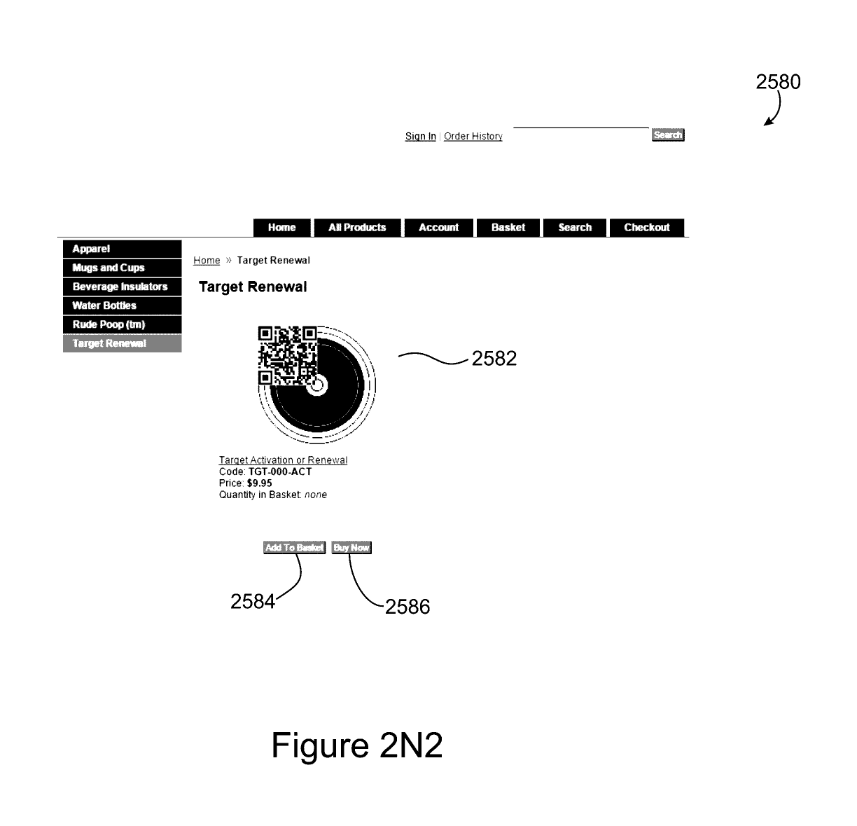

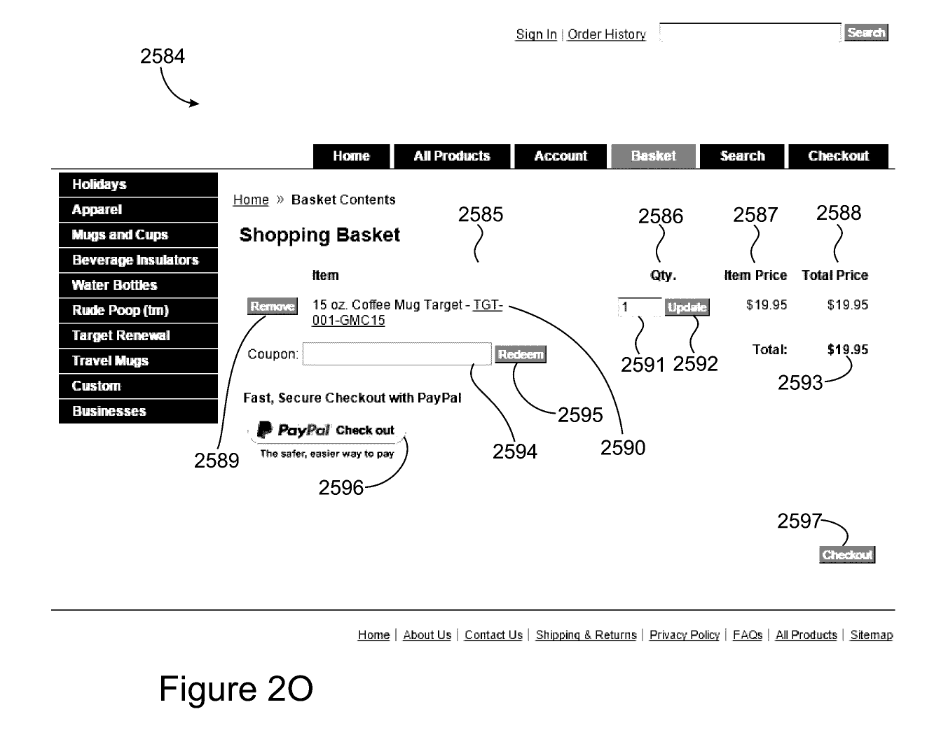

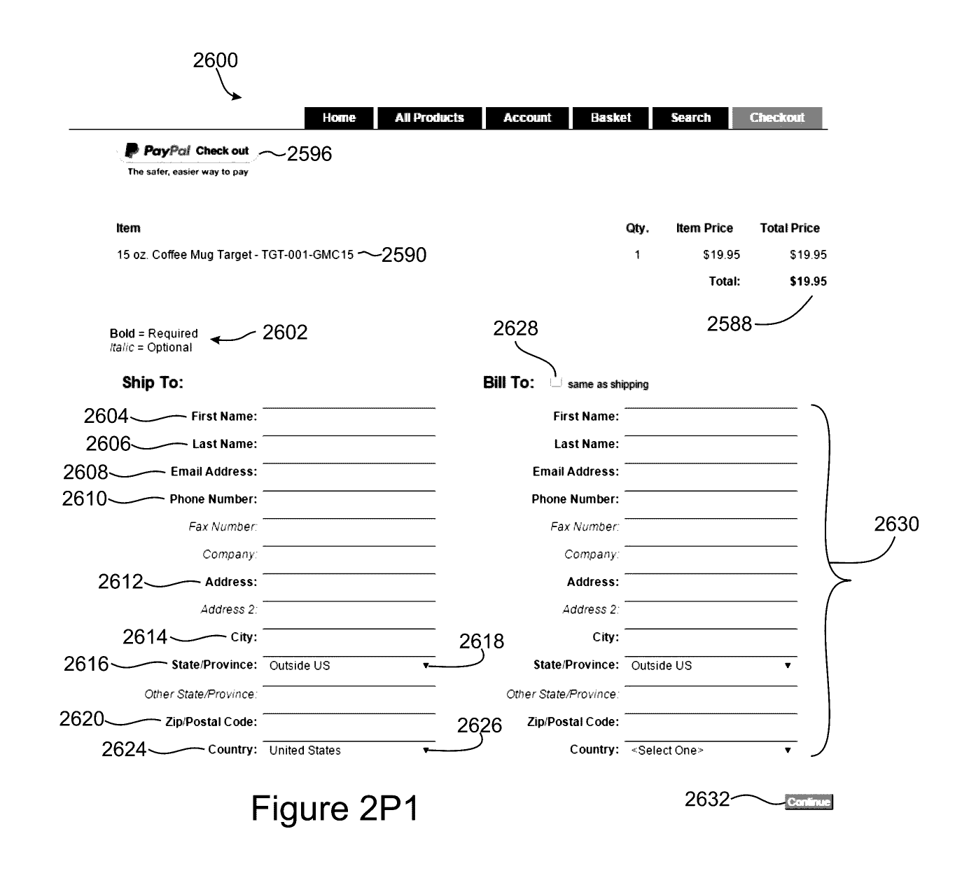

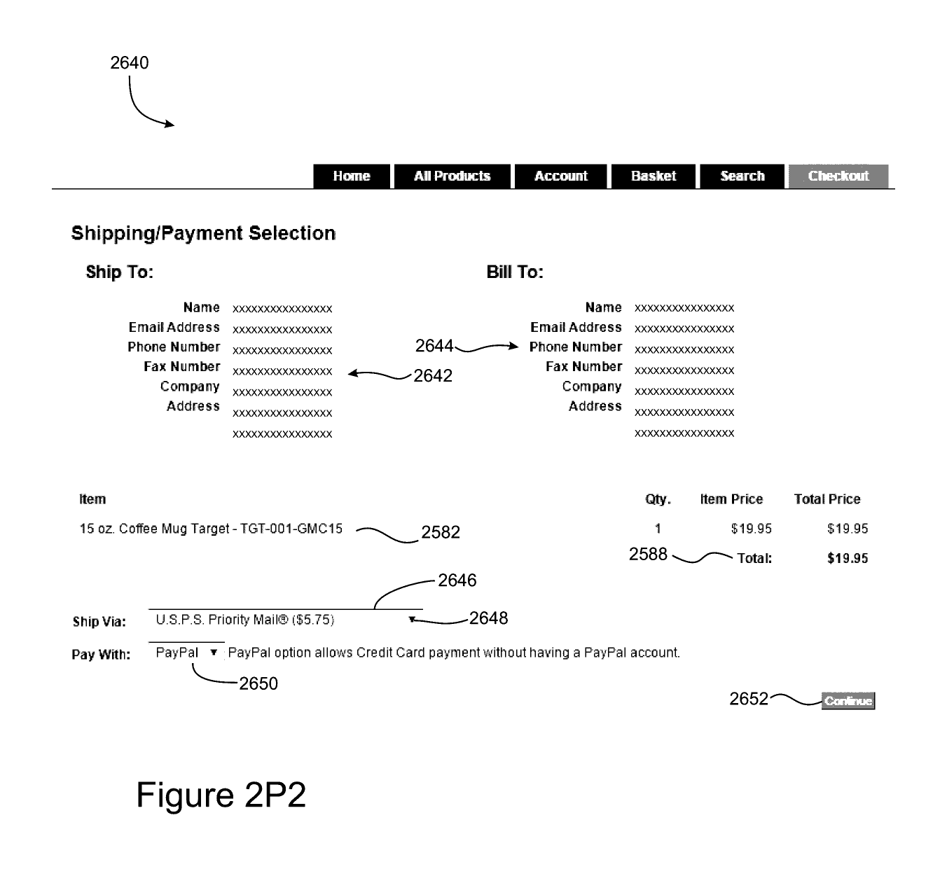

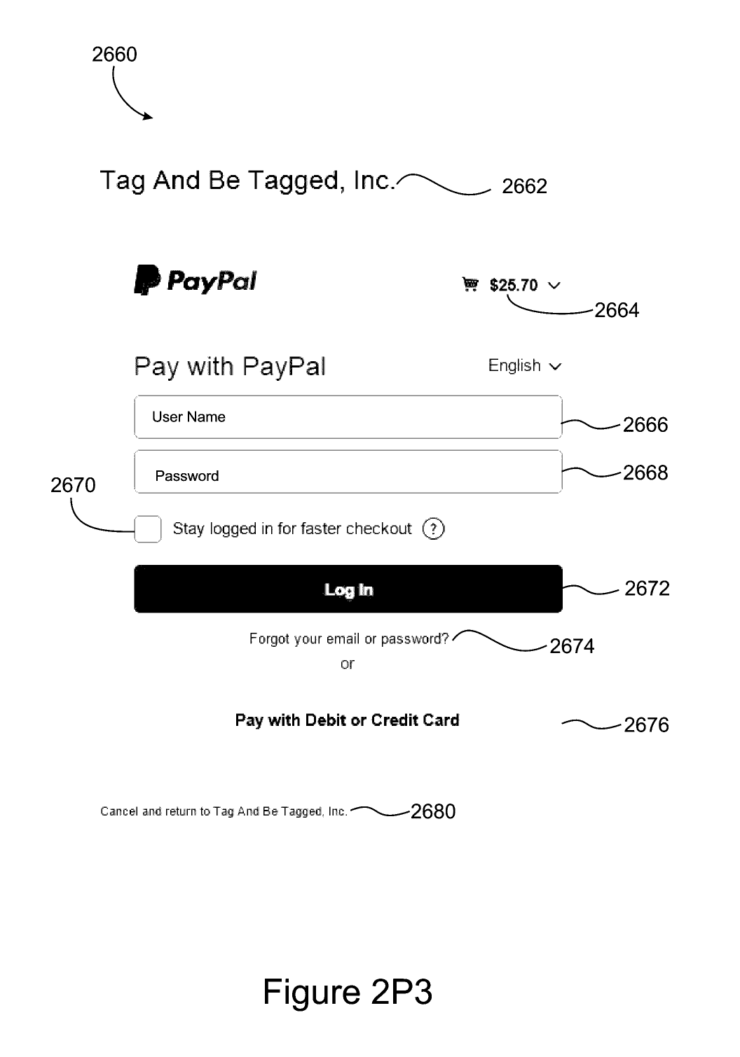

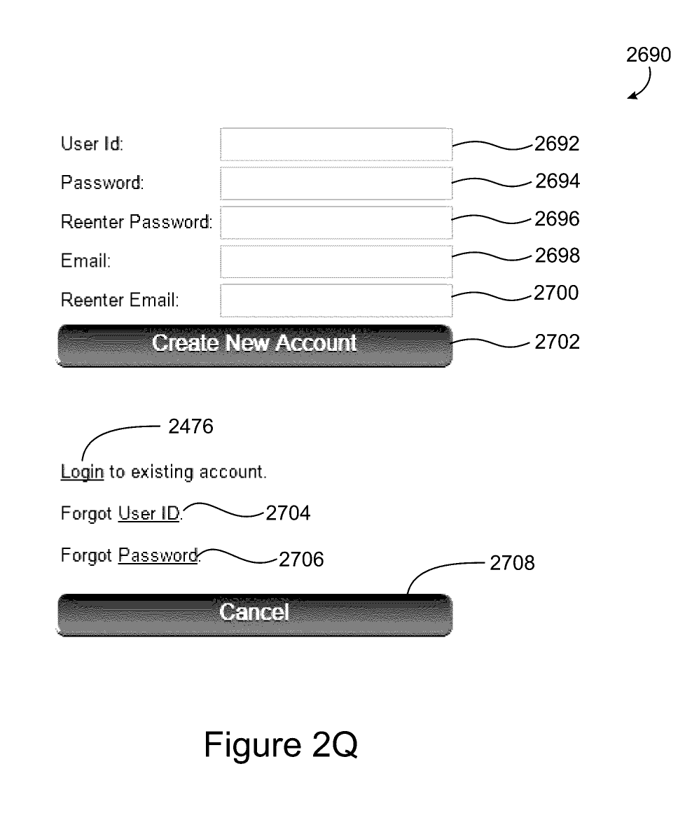

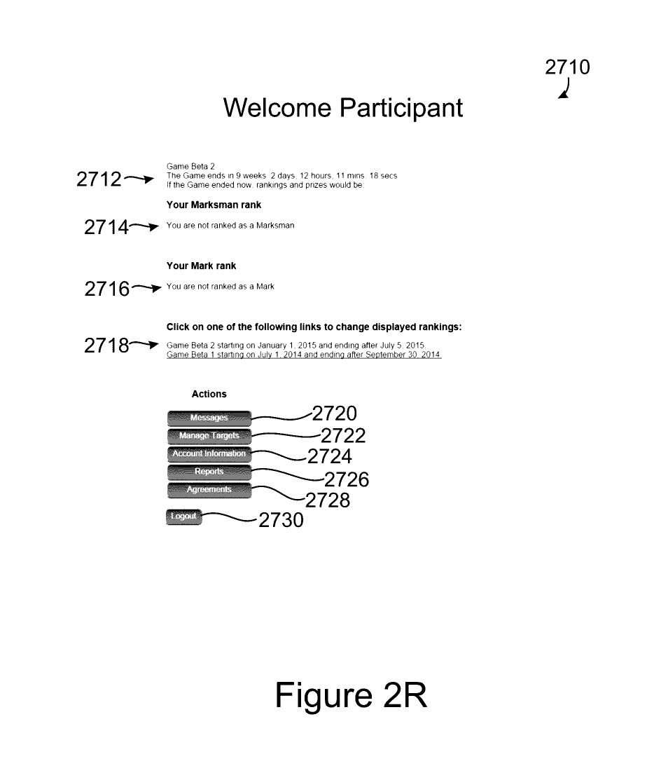

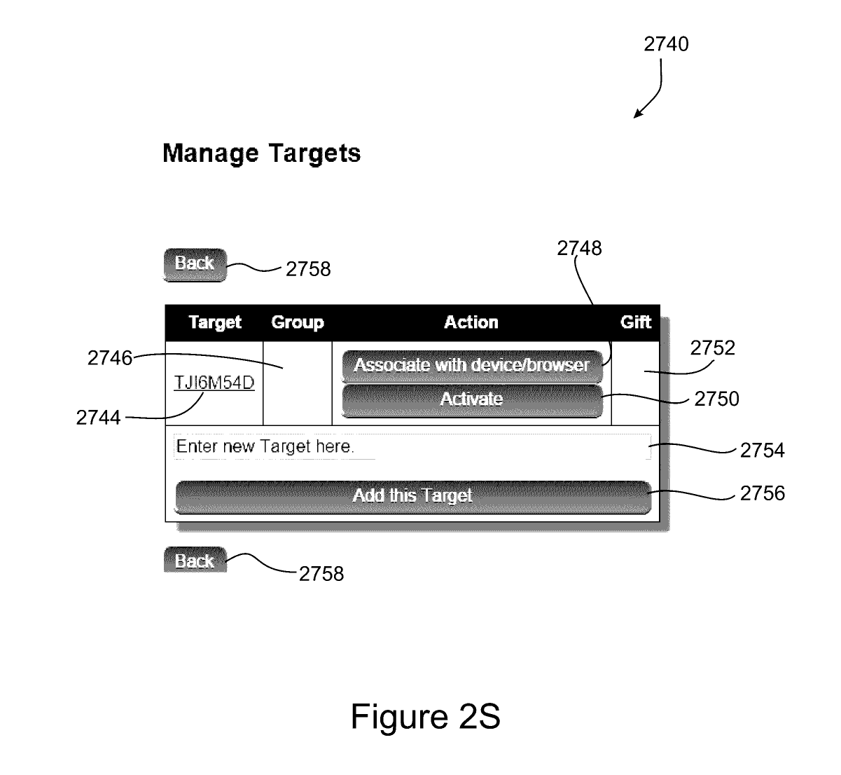

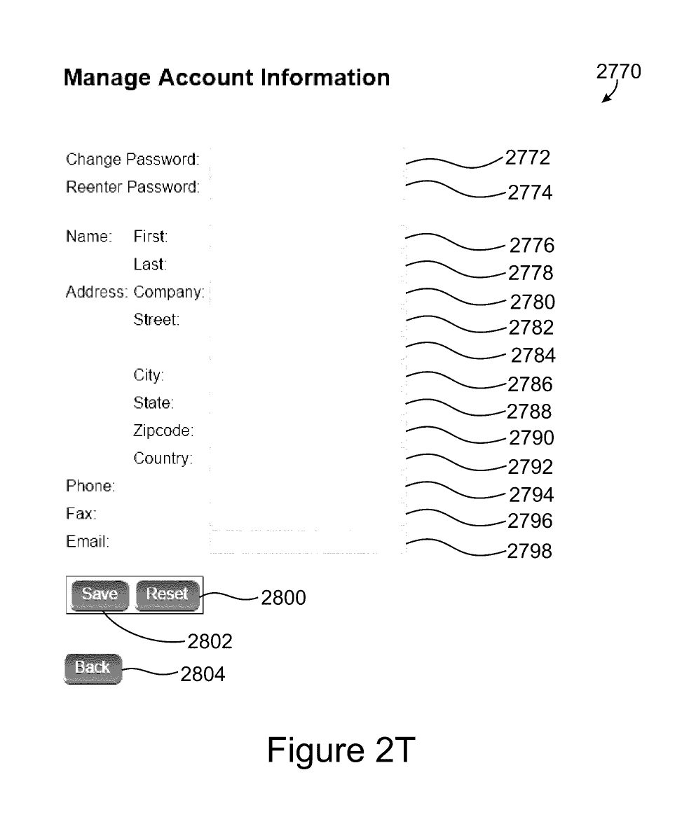

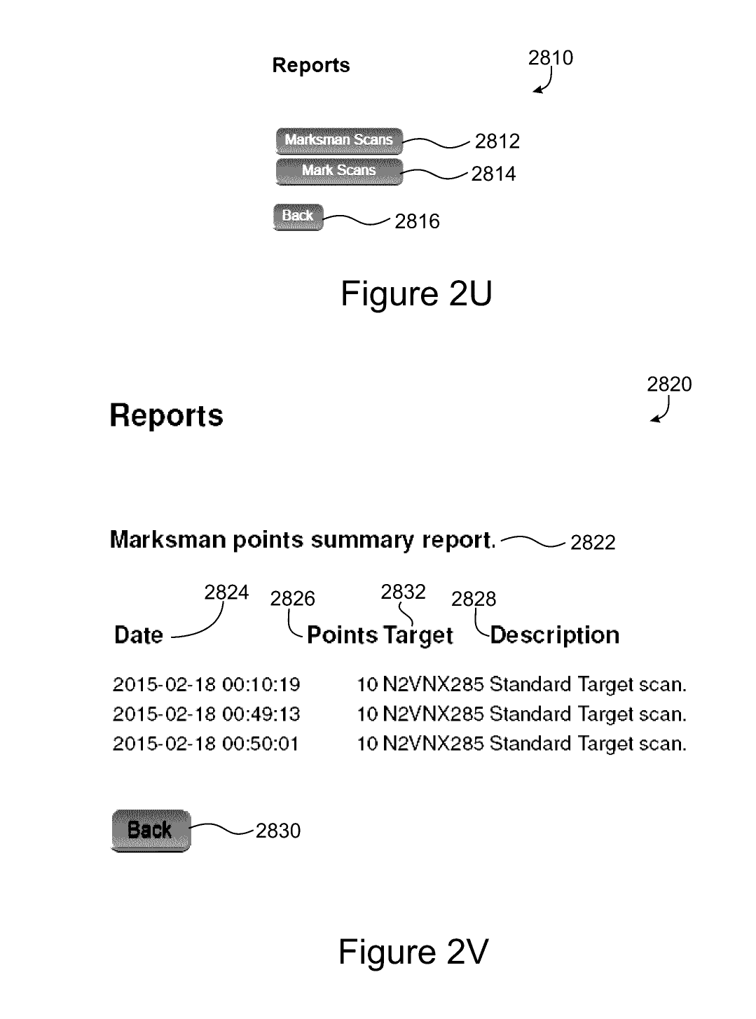

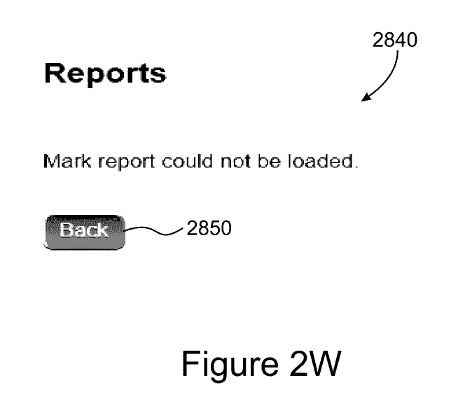

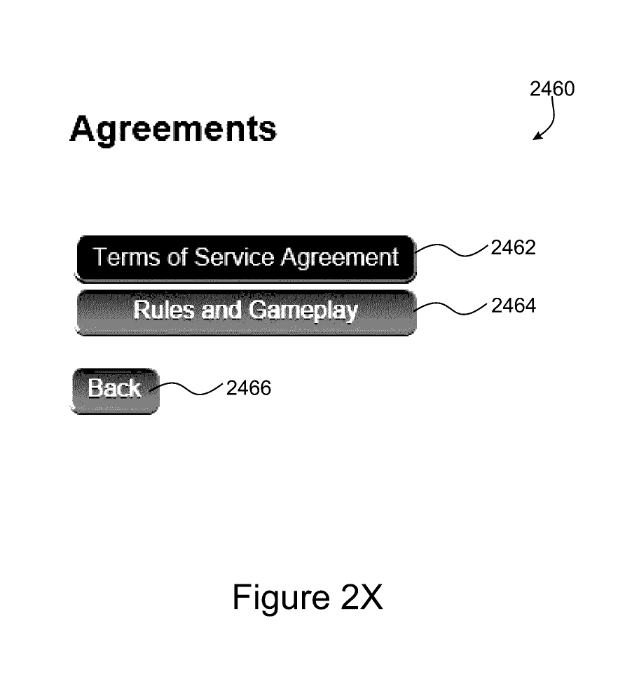

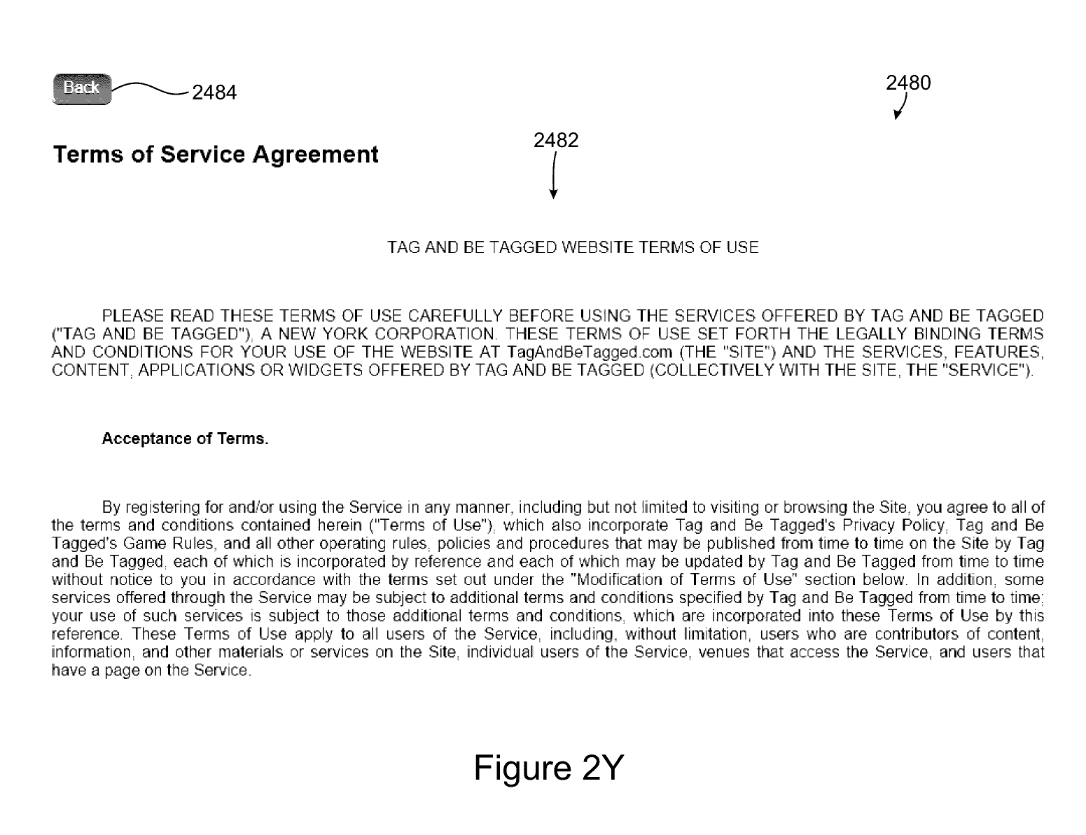

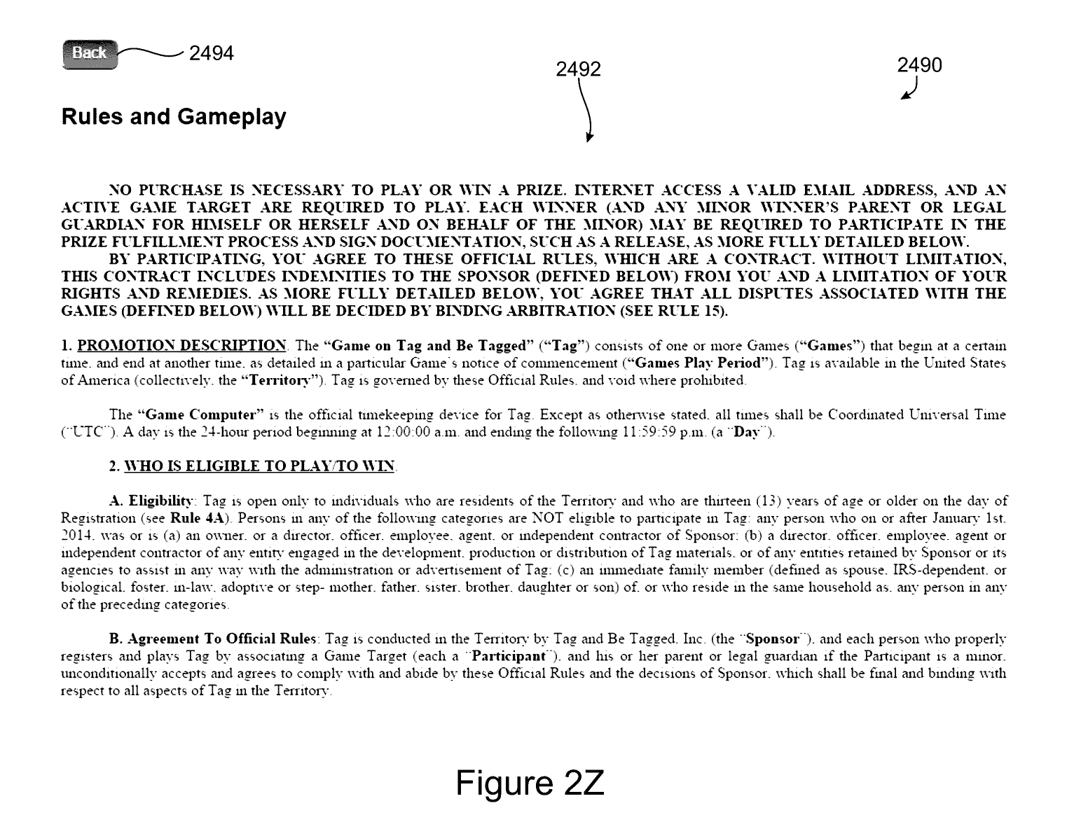

Referring now to FIG. 2A, there is shown a screen shot 2000, of a typical home page.

A Tag and Be Tagged logo 2002 is displayed in an upper left corner of screen 2000.

One or more buttons 2004 allows accessing other sites and/or services.

An “Enter Target ID” box 2040 consists of a text box 2042 into which a target ID may be entered and a check box 2046 for submitting the entered TARGET ID to the system.

A series of navigation buttons appear on screen 2000 under logo 2002 and button(s) 2004. These buttons include “Home button 2048 (shown highlighted on Home screen 2000), a Map” button 2050, an “Info” button 2052, a “Business” button 2054, a “Login” button 2044, and a “Shop” button 2056. The function of each of these buttons is discussed in detail hereinbelow.

Information regarding the current game is displayed beneath navigation buttons 2048 . . . 2056.

A message 2014 provides information regarding the last dates that targets may be purchased or gifted for the current game at reference number 2014. Purchased in this context is synonymous with activated.

A second message 2016 provides the time remaining in the current game.

Marksman Standings 2018 and Mark Standings 2028 and displayed in two respective columns. The information displayed indicates what a PARTICIPANT would win of the game ended at the instant that the page was viewed.

Marksman Standings 2018 has a Rank column 2020, a Marksman column 2022, a Points Tally column 2024, and a Cash Prize column 2026.

Mark Standings 2028 has similar columns: “Rank” 2030, “Mark” 2032, “Points Tally” 2034, and “Cash Prize 2036.

Selecting “Maps” button causes a Maps screen to be displayed. Referring now also to FIG. 2B, there is shown a Maps screen 2070. The screen may be identified by Maps heading 2072

A message 2074 informs the user that the displayed map 2080 depicts the locations of participating businesses and informs a user that clicking on a target icon 2082, 2084, etc. displays detailed information relating to the business at the clicked location.

Map 2080 may be centered on the position of the user and zoomed into street level (or other predetermined range) by selecting “My Position” button 2076. Likewise, the map may be centered on the user and zoomed back to a regional level (or other predetermined range) by selecting “My Region” button 2078. Those of skill in the art will recognize that other navigation and/or filtering (e.g., business category or business capability) tools may be provided. Also, a list of business locations with columns representing Name, Category, and Distance from User location may be provided, sortable, filterable, and searchable

Either map or satellite views, well known to users of Google Maps™, may be selected with controls 2088. Likewise, the user may zoom in our out on map 2080 using control 2090.

Clicking on target 2082 causes a business detail screen associated with target 2082 to be displayed. Referring now also to FIG. 2C, there is shown a business detail screen 2100.

An information box 2102 is overlaid on map 2080

A business name 2104 is displayed with an advertising line 2106.

A close box 2108 dismisses information box 2012 effectively and returns the user to the previous screen 2070.

The number of MARKSMAN points awarded at the selected business location 2110 is shown. The number of MARKSMAN points awarded at the selected business location 2012 is also shown. In the case of Cinema Saver, 10 MARKSMAN points are awarded and no MARK points are awarded by that business,

Returning to Map screen 2070, the use may wish to obtain information about another business. Clicking on target 2084 causes another business detail screen associated with target 2084 to be displayed. Referring now also to FIG. 2D, there is shown another business detail screen 2120.

On screen 2120, an information box 2122 for a different business is overlaid on map 2080.

A business name 2124 is displayed but with no advertising line (2106 on screen 2100-FIG. 2C).

A close box 2128 dismisses information box 2122 effectively and returns the user to the previous screen 2070.

The number of marksman points 2126 is shown. An “*” after the point number indicates that a purchase or other action is required before a target scan is allowed. A message 2132 indicates what is required for a target scan to be allowed.

Mark points 2130 are also shown. In the case of Richie's Vestal Parkway East, no mark points are awarded by that business.

When a user has finished with the Maps screens, he/she may click the “Info” button 2052 or, for that matter, any of the other tabs (e.g., Home 2048, Business 2054, Login 2044 or Shop 2056) as desired. After selecting “Info” 2052, an Info Menus is displayed. Referring now also to FIG. 2E, there is shown an Info Menus screen 2140.

An Info pull-down Menu 2142 consists of four selectable options: “Getting Started” 2144, “Scoring Points” 2146, “Game History” 2148, and “Q&A” 2150. The “Getting Started” box 2144 is highlighted. Clicking “Getting Started” 2144 causes a “Getting Started” screen to be displayed. Referring now also to FIG. 2F, there is shown a “Getting Started” screen 2160.

Getting started screen 2160 contains information text 2162 including topics Acquiring a Target 2164, Creating an Account 2166, Adding Target to Your Account 2170, and Scanning Targets and Scoring Points 2174.

Acquiring a Target 2164 provides only informational text.

Create an Account 2166 includes a link 2168 that when clicked takes a user to the create an account screen.

Add a Target to your Account heading 2170 provides a link 2172 that when clicked transfers the user to the account login screen. The user is provided with instructions for adding a target from the user's account screen.

Scan Targets and Score Points 2174 provides instructions telling the user to enter the target ID into text box 2176 and then to click the check mark 2178 to submit the information.

If the user clicks “Scoring Points” 2146 on the Information Pull-down Menu screen 2142 (FIG. 2E), the Scoring Points screen is then displayed. Referring now also to FIG. 2G, a Scoring Points screen 2180 is displayed.

Scanning Points screen 2180 contains instructions 2182 regarding how game participants may accumulate points.

If the user clicks Game History 2148 on Information Pull-down Menu 2142, the Game History screen 2200 is displayed. Referring now also to FIG. 2H, there is shown a Game History screen 2200.

Game History Screen has a list 2202 of previous games, each a clickable link, not individually identified. By clicking a link, the history for the selected game is displayed. For convenience, the game history for the selected game is displayed on the lower portion 2204 of Game History screen 2200 as illustrated herein.

If the user clicks Q&A 2150 on Information Pull-down Menu, the Q&A screen 2220 is displayed. Referring now also to FIG. 2I, there is shown a Q&A screen 2220.

Q&A screen 2220 is an information only screen that provides answers 2222 to common questions about the Tag and Be Tagged game.

If the user selects the Business icon 2054, a Business Participant screen is displayed. Referring now also to FIG. 2J, there is shown a typical Business Participant screen 2240.

Business Participant screen 2240 is design for use by a business who would like to inquire about participating in the Tag and Be Tagged game. The screen includes several text box in which the perspective business may enter Contact Name 2242, Business name 2244, Business Type (e.g. Restaurant, etc.) 2246, Business Address 2248, Phone Number 2250, an Email address 2252, and a URL associated with the business's website 2254.

A so-called captcha 2256 is displayed that the user must enter in text box 2258. Captchas (e.g., captcha 2256) are used to help ensure that a human is responding rather than a computer or other automated responder is sending the message.

Finally, the user clicks “Submit Message” button 2260 to submit the information on the form to the Tag and Be Tagged website.

If the user selects the Login Icon 2044, a Login screen is displayed. Referring now also to FIG. 2K, there is shown a typical Login screen 2470.

Login screen 2470 allows game participants to log into the Tag and Be Tagged system. A User ID 2472 and Password 2474 are first entered into their respective text boxes. The Login button 2476 is then clicked. Security system for verifying User IDs and Passwords are well known and consequently, are not further discussed or described herein.

Provisions are provided to assist a registered participant with a forgotten User ID 2478, or a forgotten Password 2480. System for providing help to bona fide registered users are also believed to be well known and they too are not further discussed or described herein.

Finally, a non-registered user may click the “Create New Account” link 2482.

A “Cancel” button 2484 returns a user to a previous screen.

If a user selects the Shop Icon 2056, A Shopping Home screen is then displayed. Referring now also to FIG. 2L there is shown a typical Shopping Home screen 2500.

Shopping Home screen 2500 provides several options. First, Targets may be purchased by clicking the “Tag and Be Tagged Store” link 2502.

Users may acquire target scanning applications for both Apple® and Android® products 2504, 2506, respectively.

Clicking Tag and Be TAGGED Store link 2502 causes a Tag and Be Tagged Store Home page to be displayed. Referring now also to FIG. 2M, there is shown a typical Tag and Be Tagged Store Home screen 2520.

The “commerce” sub-system 1009 of the Tag and Be Tagged website and system is typically provided by a commercially available ecommerce package. Such ecommerce packages are believed to be well known. Nonetheless, many of the typical ecommerce screens are shown and described herein in an attempt to provide a complete disclosure of the Tag and Be Tagged system.

At the top right portion of screen 2520 are “Sign In” and “Order History” links 2522, 2524, respectively. “Sign In” link 2522 is a sign into the store (i.e., commerce site) and should not be confused with the game log in discussed elsewhere.

“Order History” link 2524 allows a user who has made a previous purchase to review a previous order or orders.

A text box 2526 allows a user to enter a search term that is searched when the “Search” button 2528 is clicked.

A series of buttons are disposed across upper portion of screen 2520 under links 2522 and 2524. These include “Home” 2530 (shown highlighted to indicate that a user is at the “Home” screen; “All Products” 2532; “Account” 2534; “Basket” 2536; “Search” 2538; and “Checkout” 2540. Buttons 2530-2540 each provides a well-known e-commerce function and, for the most part, such functions form no part of the present invention. Further, their functions are believed to be well known to those of skill in the art and are, therefore, not fully described herein.

A series of merchandise categories, not individually identified, are displayed in a column 2542. Each category in column 2542 allows shopping for merchandise in the selected category when clicked.

A Tag and Be Tagged logo 2546 identified as a service mark of Tag And Be Tagged, Inc.

A “Return to Game” link 2544 allows a user to exit the “Store” portion of the website.

Finally, an additional series of links are disposed along the bottom edge of Store Home screen 2520. These additional links are not individually identified and include “Home”, “About Us”, “Contact Us”, “Shipping & Returns”, “Privacy Policy”, “FAQs”, “All Products”, and “Sitemap”. These links are common e-commerce links and the function of each is believed to be well known to those of skill in the art. Consequently, none of these links 2548 are discussed in more detail herein.

If a shopper selects “All Products” 2532 from screen 2520, a “Product” screen 2550 is displayed. Referring now also to FIG. 2N1, there is shown a screen shot of a typical product screen 2550. Screen 2550 is excerpted from an actual website screen and for clarity displays only a limited number of products.

A “Sort By” drop down box 2552 with a control 2554 allows a shopper to choose how products are sorted for display,

An additional “View” drop down box 2556 with associated control 2558 allows a shopper to choose the number of products to be displayed on each screen.

A control 2560 allows a shopper to select a particular page of products to be displayed.

Each product typically has a name 2562, a code 2564, and a price 2566. In addition, the quantity of the product currently in the basket is shown, reference number 2568.

Each product has a pair of associated buttons: An “Add to Basket” button 2572 and a “Buy Now” button 2570.

Assume the shopper wishes to buy a T-Shirt Target (2562) having a Code TGT-001-VBT (2564) with a price of $19.95 (2566). The shopper clicks either “Add to Basket” button 2572 or “Buy Now” button 2570. In this case, the shopper clicks “Add to Basket: button 2572.

By clicking “Basket” button 2536 near the top of screen 2550, a “Shopping Basket” screen is displayed. Referring now also to FIG. 2O, there is shown a screen shot of a typical “Basket” screen 2584.

Shopping Basket screen 2584 shows a list of products a shopper wishes to purchase. Four columns: “Item” 2585, “Qty.” (i.e., Quantity) 2586, “Item Price” 2587, and “Total Price” 2588.

The shopper currently has a single item in his/her Shopping Basket”—a 15 oz. Coffee Mug Target. The name and code are displayed in the Item column 2590.

A “Remove” button 2589 when clicked removes the item from the Shopping Basket.

The quantity is displayed in a text box 2591 associated with an “Update” button 2592. Clicking “Update” button 2592 allows a shopper to modify the quantity he/she wishes to purchase. When the quantity is updated, the Total Price column 2588 is updated with a value calculated as the product of the Item Price” 2587 and the Quantity 2591.

If the shopper has a coupon code, it may be entered in text box 2594. Once a coupon code is entered, the “Redeem” button 2595 is clicked. Software believed to be well known to those of skill in the art is typically used to verify the authenticity of the entered coupon code in text box 2594.

The shopper has completed his/her shopping, he/she may checkout using PayPal® 2596 or with a conventional checkout by clicking “Checkout” button 2597. As PayPal® checkout is believed to be well known to those of skill on the art, that process is not further discussed or described herein.

If the shopper clicks “Checkout” button 2597, a checkout screen is displayed. Referring now to FIG. 2P1, there is shown a first of three checkout screens, generally at reference number 2600.

An option to checkout using PayPal 2596 is repeated at the top of Checkout screen 2600.

The list of items in the shopping cart is repeated, in this exemplary case, a single 15 oz. Coffee Mug Target 2590 having a total price of $19.85 2588.

An information statement 2602 indicates that field names in bold text are required fields while italicized field names are optional fields.

A column of “ship to” fields contain information for the party to whom the merchandise is to be shipped. Only the required fields are specifically identified.

Required fields, identified in bold text, include: “First Name” 2604; “Last Name” 2606; “Email Address” 2608; “Phone Number” 2610; “Address” 2612; “City” 2614; State/Provence” 2616; “Zip/Postal Code” 2620; and “County” 2624.

Both “State/Province” filed 2616 and “Country” field 2624 is inputted via drop down boxes, each having a control 2618, 2626, respectively.

A checkbox 2628 may be checked to indicate that the shopper's billing address is the same as his/her ship to address. Once checked, all bill to fields 2630 are removed from the screen. If left unchecked, the shopper must enter all the required information in the bill to fields 2630.

When all information is filled in, the shopper may click “Continue” button 2632. Upon doing so, the second checkout screen is then displayed. Referring now also to FIG. 2P2, there is shown the second of three checkout screens, generally at reference number 2640.

The information for Ship To address 2642 and Bill To address 2644 is reproduced.

Again the merchandise is displayed. In this case the single item 15 Oz Coffee Mug 2582 and its Total Cost 2588 are displayed.

A “Ship Via” drop down box 2646 allows the shopper to select a shipping means using control 2648.

A Pay With” drop down box 2650 allows the shopper to select a means of payment. Tag and Be Tagged, Inc. has chosen to use PayPal as their accepting agent for credit card payments. Consequently, the only payment means is PayPal.

When ready, the shopper clicks “Continue” button 2652. Upon doing so, the third checkout screen is displayed. Referring now also to FIG. 2P3, there is shown a typical third checkout screen, generally at reference number 2660. Screen 2660 is actually a PayPal screen with the vendor name (i.e., Tag and Be Tagged, Inc.) 2662 displayed.

The total amount to be paid, in his case the total amount is $25.70 calculated from the 15 oz. Coffee Mug Target ($19.95) plus the shipping cost 2648 of $5.75.

If the shopper has a PayPal account, he/she may sign in by entering his/her user name 2666 and password 2668 and clicking: Log In” button 2672. An optional feature includes a check box 2670 by which the shopper may choose for PayPal to keep the shopper logged in.

If the shopper has forgotten his/he user name or password, a link 2674 may be used to recover or reset one or both the user name and password.

If the shopper does not have a PayPal account nor does not wish to use his/her account, they may press the “Pay with Debit or Credit Card” button 2676. PayPal then accepts the shopper's Credit or Debit Card information in a conventional manner believed to be well known to those of skill in the art. No further illustration or discussion in included herein for the actual credit or debit card processing.

A “Cancel and return to Tag and Be Tagged, Inc.” 2680 is provided so the shopper can easily exit from PayPal.

Referring again to “Log In” screen 2470 of FIG. 2K, if the user needs to create a new account, he/she must click the “Create New Account” link 2482. Upon doing so, a Create a New Account screen is displayed. Referring now also to FIG. 2Q, there is shown a typical “Create a New Account” screen 2690.

On “Create a New Account” screen 2690, a new user may enter a proposed user ID, text box 2692 and a proposed password, text box 2694. The user must then re-enter the proposed password, text box 2696. A check may be performed at this point to ensure that the two entries of the proposed password are identical. Also, the password may be checked for adequacy (e.g., sufficient length, containing both upper case and lower case alphabetic characters, containing a numeral, etc.). Methods for performing such checks are believed to be well known and, as such, form no part of the present invention. For these reasons, such check procedures are not further discussed or described herein.

The user next enters his or her Email address, text box 2698 and then renters the Email address in text box 2700. A similar check may be performed to ensure that the two Email address entries are identical.

Finally, the user must click “Create a New Account” button 2702 to establish the new user account.

Cancel control 2708 returns the user to the home screen 2000.

Upon signing in, the new user is greeted by the Welcome screen 2710, FIG. 2R.

Referring now also to FIG. 2R, screen 2710 first provides the signed-in PARTICIPANT general game information 2712. In the embodiment chosen for purposes of disclosure, the game identification, the ending date and time of the game, and the PARTICIPANT ranking if the game ended now. It will be recognized that other game-related information could be provided.

Game information 2712 includes the PARTICIPANT's MARKSMAN score 2714 and MARK score 2716.

Links are provided to obtain information on other games, 2718.

A series of buttons 2720-2730 are provided.

Clicking “Messages” button 2720 provides a screen, not shown, containing any messages for the PARTICIPANT. Messages to the PARTICIPANT may give dates and times for starting and concluding a game and other information such as notifications of ranking, ranking changes, daily specials, new business participants, etc.

Clicking “Manage Targets” button 2722 displays a Manage Targets screen. Referring now also to FIG. 2S, there is shown a screen shot of a typical “Manage Targets” screen 2740.

The status of any PARTICIPANT TARGETS 2744 is shown. In the example, the PARTICIPANT has a single associated TARGET.

Two buttons are provided to either “Associate with Device/Browser” 2748 and “Activate” 2750. Associating a PARTICIPANT's TARGET to a mobile device/browser designates the unique TARGET ID that will be sent to the sever 1002 upon a SCAN of another PARTICIPANT's TARGET. The Activate button 2750 is displayed when a TARGET is not valid for a current game. Pressing the Activate button 2750 will start the activation process for a current game.

A TARGET ID may be entered in text box 2754. Once the TARGET ID is entered, clicking “Add this Target” button 2756 adds the TARGET.

Once a user account is established, the user, upon registration of a TARGET is then a PARTICIPANT.

The Group field 2746 shows a Group Name if and when the TARGET is assigned to a GROUP. Groups are used primarily with BUSINESS PARTICIPANTS and the special features of Target Management associated with BUSINESS PARTICIPANTS are discussed in detail hereinbelow.

Gift field 2752 may display three different possibilities. The field is typically blank if table row is associated with a primary TARGET. Gift field 2752 will display “Gift” for TARGETS not currently marked for gifting. Finally, Gift field 2752 will display “Ungift” for TARGETS currently marked for gifting. Gifting TARGETS provides a method for PARTICIPANTS to score points by providing a gift TARGET to someone who eventually becomes a PARTICIPANT.

Clicking one of the “Back” buttons 2758 returns the PARTICIPANT to the Welcome Participant screen 2710.

Clicking “Account Information” button 2724 from screen 2710 displays a “Manage Account Information” screen 2770. Referring now also to FIG. 2T, there is shown a screen shot of a typical “Manage Account Information” screen 2770.

PARTICIPANT's password may be changed by typing a new password in text box 2772. As when a password was initially established, the newly-entered password must be re-entered in text box 2774. The password check described hereinabove also apply to a changed password.

PARTICIPANT may change his or her demographic information by making corrections to the fields: First Name 2776; Last Name 2778; Company 2780; Street Address (first line) 2782; Street Address (second line) 2784; City 2786, State 2788; Zip code (i.e. postal code for non-US addresses) 2790; Country 2792; Phone (voice) 2794; Fax 2796; and E-mail Address 2798.

After all modifications/corrections have been made in fields 2772-2798, PARTICIPANT clicks either “Save” button 2802 that saves the corrections or the “Reset” button 2800 that removes all the corrections.

Clicking the “Back” button 2804 returns the PARTICIPANT to the Welcome Participants Screen 2710.

A “Manage Groups/Locations screen is accessed from screen 2710 (FIG. 2R) when a PARTICIPANT is a business, not shown. The term business is used to refer to organization other than businesses that may be PARTICIPANTs in a Tag and be Tagged game. A business is identified by a “business” attribute in the account information.

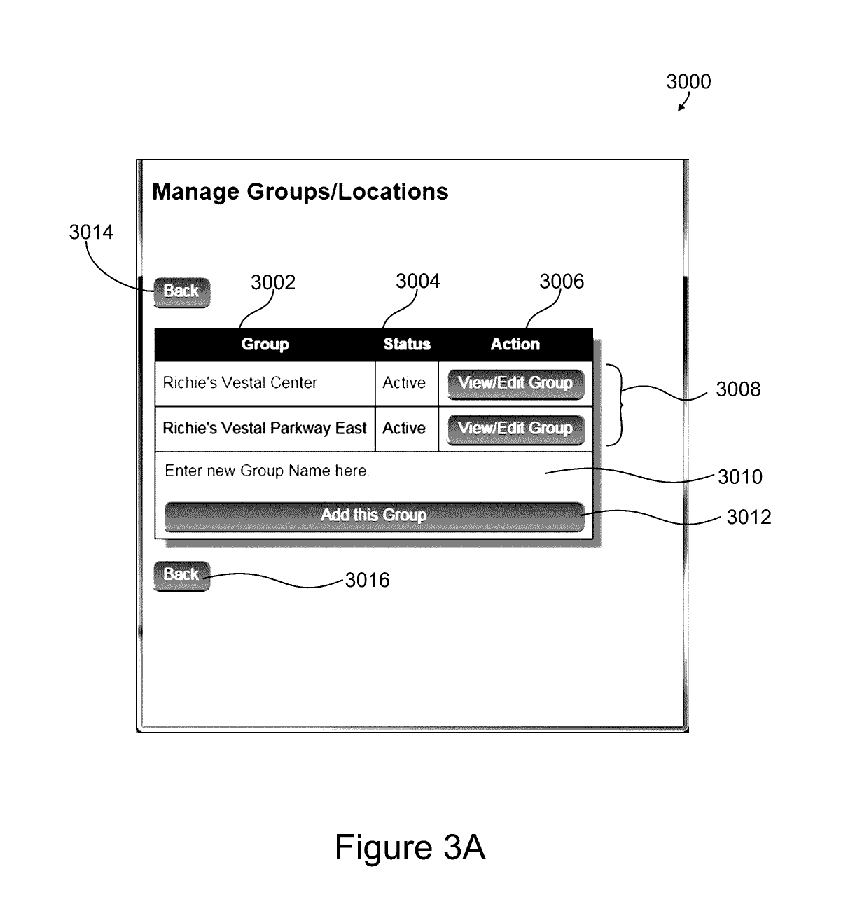

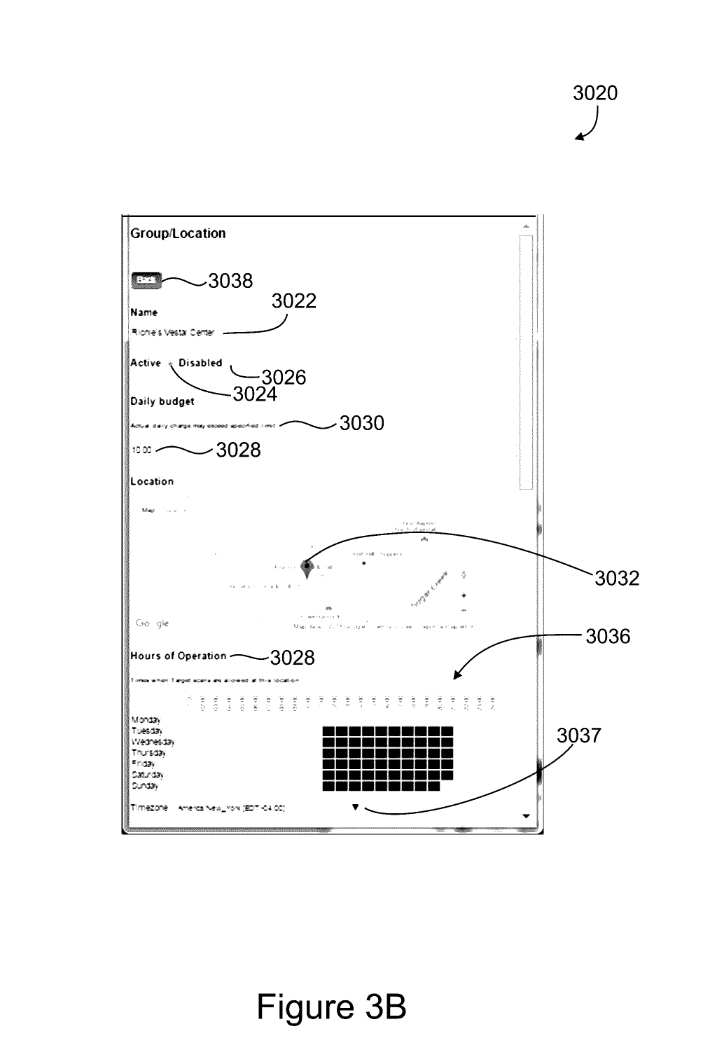

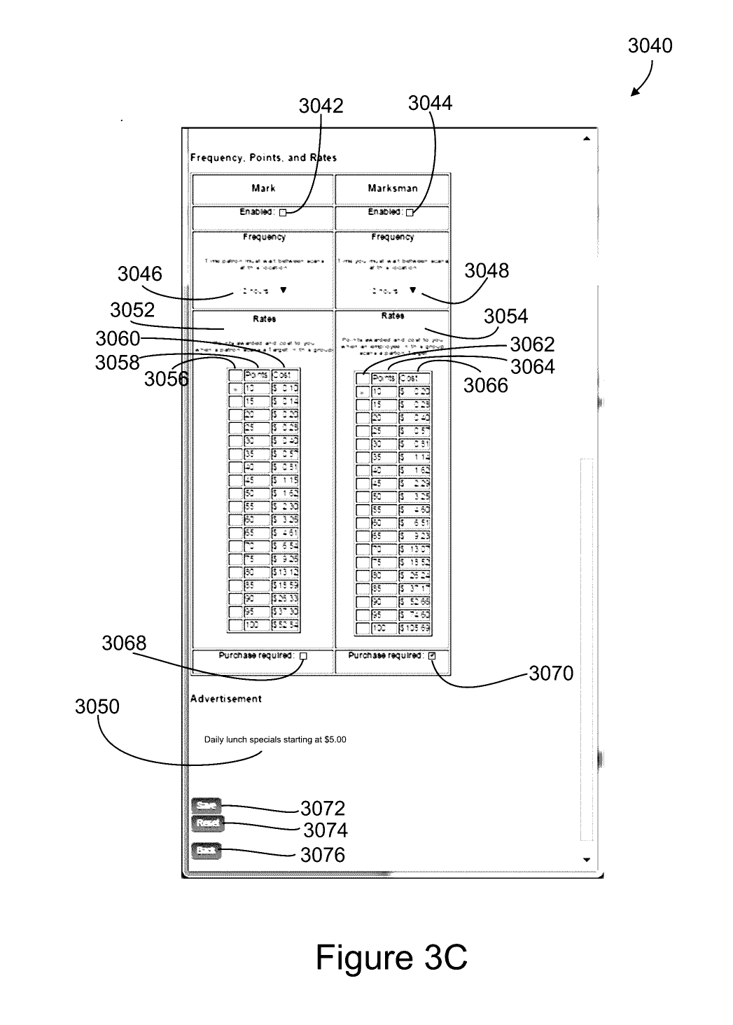

Referring now also to FIG. 3A, there is shown a Manage Groups Screen, generally at reference number 3000.

A list of businesses has three columns: a “GROUP” 3002, “Status” 3004 and “Action” 3006. “Group” column 3002 displays a list of existing GROUPS (e.g., business locations). “Status” column 3004 displays where the GROUP is active or inactive. “Action” column 3006 contains a “View/Edit Group” button 3008.

A text entry field 3010 allows entry of the name of a new GROUP. An “Add the Group” button 3012 enters the GROUP to the USER/PARTICIPANT account. For each GROUP there is a set of attributes accessible by selecting “View/Edit Group” button 3008.

If a user selects a “View/Edit Group” button in “Action” column 3006, the pair of data entry screens 3020, 3040 and displayed with all existing data for the selected GROUP displayed.

Referring now also to FIGS. 3B and 3C, there are shown screen shots of two portions 3020 and 3040 of a GROUP/LOCATION data entry screen. Data entry screens 3020, 3040 are used to enter as new GROUP, or to modify information associated with an existing GROUP.

If data entry screens 3020, 3040 for a new GROUP are accessed, only the Name 3022 is valid. Otherwise, screens 3020 and 3040 are populated with default information.

The Business Location Name 3022 is displayed and may be edited as desired.

The business's “Active” or “Disabled” status is set or altered using radio buttons 3024, 3026, respectively.

The Daily Budget for the business is displayed 3028 along with the message “Actual daily charge may exceed the specified limit” 3030.

A Business Location 3032 is shown on a map. The displayed region of the map may be altered using techniques believed to be well known to those of skill in the art. Clicking or tapping a location adds or relocates a marker 3032.

Hours of Operation are selected by checking a matrix of check boxes 3036 with hours displayed across the top along an “X” axis and the days of the week displayed along the “Y” axis. While 1 hour increments using a 24 hour clock have been chosen for purposes of disclosure, it will be recognized that matrix of check boxes 3036 could be expanded to accommodate finer time increments.

A “Time Zone” drop down box 3037 allows the business owner to select the time zone where his/her business operates.

A “Back” button 3038 returns a user to screen 3000, FIG. 3A.

Whether MARK and/or MARKSMAN points are awarded by the business are enabled by checkboxes 3042 and 3044, respectively.

The allowed frequency of scanning for MARK and MARKSMAN points is determined by values 3046 and 3048, respectively. These values represent the time that a MARK or MARKSMAN must wait between scans for a subsequent SCAN to be performed.

Text 3050 is an advertising message that the business may enter. Text 3050 is displayed when detailed information is presented (2106 FIG. 2C) in response to “clicking” a location such as 2082-2084 (FIG. 2B).

Two columns 3052, 3054 display the points to be awarded 3058, 3064 and the cost for the chosen number of points 3060, 3066 for MARKS and MARKSMAN, respectively.

Columns of radio buttons 3056, 3062 for MARK and MARKSMAN, respectively, are associated with each pair of points 3058, 3064 and costs 3060, 3066. In the example chosen for purposes of disclosure, radio buttons associated with 10 points and $0.10 has been selected. For the MARK (i.e., points awarded and cost to the business when a PARTICIPANT scans a location TARGET). Also radio buttons associated with 10 points at $0.20 has been selected for MARKSMAN (i.e., points awarded and cost to a business when a PARTICIPANT is scanned by a user using a TARGET associated with the GROUP).

Each column 3052, 3054 has at its bottom an additional check box 3068, 3070, respectively, to indicate that a “purchase” must be made before a scan is validated. As used here, the term purchase is intended to refer generically to an action (e.g., a test drive at a car dealership, etc.) that must be taken by a patron of a business location. In the example chosen for purposes of disclosure, box 3068 remains unchecked while box 3070 is checked.

Additional parameters such as proximity (i.e., a maximum distance from a business) where a scan is valid causing a MARKSMAN to be in the vicinity of a business before a SCAN of a TARGET, perhaps on a document such as a coupon, brochure, etc. is validated.

A “Save” button 3072 saves new or changes data.

A “Reset” button 3074 either clears screens 3020, 3040 or discards changes made to an existing GROUP.

A first “Back” button 3038 near the top of screen 3020 and a second “Back” button 3076 near the bottom of screen 3040 returns the user to screen 3000 (FIG. 3A).

Clicking “Reports” button 2726 transfers the PARTICIPANT to a “Reports Menu”. Referring now also to FIG. 2U, there is shown a screen shot of a typical “Reports Menu” screen 2810.

“Reports Menu” screen 2810 allows a PARTICIPANT to select MARKSMAN SCANS Report by clicking “Marksman Scans” button 2812. The PARTICIPANT is then transferred to “Marksman Scans” screen 2820. Alternately, the PARTICIPANT may select the Mark Scans report by clicking the “Mark Scans” button 2814. Clicking the Mark Scans control 2814 transfers the PARTICIPANT to the Mark Scans screen 2840.

Clicking Back Button 2816 returns the PARTICIPANT to the Welcome Participants screen 2710.

If the PARTICIPANT click “Marksman Scans” button 2812, a Marksman Scans screen is displayed. Referring now also to FIG. 2V, there is shown a screen shot of a typical “Marksman Points Summary” report screen 2820.

A heading 2822 identifies the report as the “Marksman Scan Summary Report.”

Columns “Date” 2824; “Points” 2826, “Target” 2832; and “Description” 2828 are provided. In the report shown, four lines of data are provided.

“Back: button 2830 returns the PARTICIPANT to the “Reports Menu” screen 2810.

If the PARTICIPANT clicks “Mark Scans” button 2814, a “Mark Scans” screen is displayed. Referring now also to FIG. 2W, there is shown a screen shot of a typical “Marks Points Summary” screen 2840.

A “Back” button 2850 returns the PARTICIPANT to the “Reports Menu” screen 2810

From the “Welcome Participant” screen 2710, if the PARTICIPANT clicks “Agreements” button 2728, an “Agreements Menu” screen is displayed. Referring now also to FIG. 2X, there is shown a screen shot of a typical “Agreements Menu” screen 2460. This screen may selectively display all agreements or only agreements applicable to the signed-in PARTICIPANT.

PARTICIPANTS may choose to view “Terms of Service Agreement” by clicking “Terms of Service Agreement” button 2462. Clicking Terms of Service button 2462 causes a Terms of Service screen to be displayed. Referring now also to FIG. 2Y, there is shown a screen shot of a typical “Terms of Service” screen 2480.

Screen 2480 displays only a portion of the complete terms of service 2482, the remainder being viewable on the website using a scroll bar, not shown.

Clicking back button 2484 returns the PARTICIPANT to “Agreements Menu” screen 2460

If however, the PARTICIPANT chooses to view “Rules and Gameplay” by clicking “Rules and Gameplay” button 2464 a “Rules and Gameplay” screen is then displayed. Referring now also to FIG. 2Z, there is shown a screen shot of a typical “Rules and Gameplay” screen 2490.

“Rules and Gameplay” screen 2490 has a partial display of the rules and gameplay information 2492 excerpted from the complete “rules and Gameplay” available on the website.

Clicking “Back” button 2494 returns the PARTICIPANT to the “Agreements Menu” screen 2460. Clicking “Back” button 2466 returns the PARTICIPANT to the “Welcome Participant” screen 2710.

The website and the game functions available thereat have been discussed. The game itself may now be described.

The terms SCAN and SCANS are used typically to refer to the machine reading of a TARGET using a TOOL. As discussed hereinabove, a TARGET ID may alternately be manually entered.

TOOL/TOOLS typically consist of scanners forming a part of a smart phone, a tablet, or other portable electronic devices. Other readers adapted to read the particular form of embedded machine readable information are believed to be well known and, when appropriate, may be used to SCAN a TARGET.

Alternately, a unique identification of a TARGET may be manually read and entered into the website as discussed in detail hereinabove.

In the embodiment chosen for purposes of disclosure, the scanner is assumed to be either a browser based scanner or a dedicated “app” associated with a smart device. Consequently, the QR code and (possibly other representations associated with each TARGET) allows the Tag And Be Tagged game to be web-based; the embedded URL (uniform resource locater) that automatically directs the browser of the electronic device scanning the QR code or other representation of a TARGET to a landing page at the website and additionally submits information representing the TARGET's unique identification code and browser codices such as the unique TARGET ID associated with the smart device/browser. This strategy provides benefit to both PARTICIPANTS and non-PARTICIPANTS. If only a TARGET representation that only included the TARGET unique identification code would not provide much use to non-PARTICIPANTS.

In alternate embodiments of the novel system, dedicated “apps” may be provided that do not rely on the browser of the electronic device but may communicate directly with the system without need put take a user directly to a landing page or other predetermined site because the user would already be interacting with the system through the app.

A subset of the SCAN information may be validated prior to submittal (submission?). Also, a subset of SCAN information may be validated after submittal (submission?) but prior to being placed in the Scan Table IV.

In some instances, SACN criteria may cause additional CLIENT information to be submitted automatically (e.g., mobile device position). Additional information such as a survey may be manually submitted.

The SCAN information is placed in the Scan Table (Table IV).

TABLE V
Scans

| Field Name | Field Type | Field Attribute |
|---|---|---|
| Index | Big Integer | 8, Unsigned |
| Scan Code | Character | 10 |
| Type | Tiny Integer | 3 Unsigned |
| Game Index | Big Integer | 8, Unsigned |
| Marksman Target Index | Big Integer | 8, Unsigned |
| Marksman Participant Index | Big Integer | 8, Unsigned |
| Marksman Transfer from Target Index | Big Integer | 20, Unsigned |
| Marksman Group Index | Big Integer | 8, Unsigned |
| Marksman Points | Integer | 4 |
| Marksman Points Mark Cost | Decimal | 10, 2 |
| Marksman Points Invalid | Tiny Integer | 3 |
| Mark Target Index | Big Integer | 8, Unsigned |
| Mark Participant Index | Big Integer | 8, Unsigned |
| Mark Transfer from Target Index | Big Integer | 20, Unsigned |
| Mark Group Index | Big Integer | 8, Unsigned |
| Mark Points | Integer | 4 |
| Marksman Points Marksman Cost | Decimal | 10, 2 |
| Marksman Points Invalid | Tiny Integer | 3 |
| Geo Latitude | Floating | 10, 6 |
| Geo Longitude | Floating | 10, 6 |
| Geo Timestamp | Big Integer | 8, Unsigned |
| Timestamp | Timestamp | |

As previously mentioned, the game itself is played by multiple PARTICIPANTS.

Each PARTICIPANT is expected to possess an appropriate SCANNING mechanism (i.e., scanning TOOL), not shown. The TOOL must be associated with a TARGET. The TOOL is used to capture and submit SCAN information to a GAME server. When a TARGET is SCANNED, its embedded information is typically stored in a SCAN queue in cases where the Internet is temporarily unavailable. A browser-based user interface is typically the default user interface. Optionally, an app-based user interface may store a scanned TARGET along with other information used to validate a SCAN (e.g., lat., long., time) until the SCAN is submitted, processed, and acknowledged by the system. Initially, the SCAN queue can be managed by third party QR code SCAN or other appropriate software. The QR code SCAN software may pass an embedded URL to a browser on the same device causing the game web site to be invoked.

Suitable TOOLS include electronic devices, such as smart phones, tablets, or other portable electronic having a camera, assuming a TARGET has an optically scanable unique identification code such as a QR code. If the TARGET has a non-optically scanable unique identification, an appropriate TOOL suited to the particular technology must be used to interpret the TARGET's embedded unique identification code. Consequently, as used herein, the term, “SCAN,” therefore, is intended to include “reading” a TARGET with an appropriate TOOL including, but not be limited to, RF readers (e.g., RFID transponders), audio receiving readers, optical or laser receiving readers, or IR or UV receiving readers.

If the TOOL is not associated with a PARTICIPANT or account, the SCANNED TARGET information may be stored in the browser device, for example, such that it is available when an account is eventually created so that SCANNED TARGET may be credited to the PARTICIPANT. This strategy may also be used to award points for promoting the game.

In addition to information embedded in the TARGET (i.e., identifying the MARK) and information stored in the TOOL (i.e., identifying the MARKSMAN), geographical location, and/or geolocation, which is a term of art that represents location, time, and possibly other characteristics, platform (i.e., TOOL) information, and other miscellaneous information may be submitted when a SCAN is performed and/or processed or soon thereafter.

Points can be awarded in unlimited ways, consistent with an unlimited number of formulas. Such point awarding can trigger an unlimited number of events (e.g., displaying cash or product prizes, advertisements, current standings, and/or crossing milestone thresholds). Such formulas are under the control of Game Administrator 1030 and/or a SPONSOR 1026a, 1026b . . . 1026n who may control certain game parameters that, among other things, are related to specific formulas related to the awarding of points for SCANS of TARGETS assigned to his/her business GROUP.

Some exemplary point awarding examples are now provided. For example, MARKSMAN points may be scored by purchasing one or more TARGETs, marking one or more TARGETS as gifts, and providing gifted TARGETS to someone who eventually becomes a PARTICIPANT.

MARK points can be scored by wearing or displaying TARGETS and being SCANNED by persons create a new account and add a TARGET or who eventually become PARTICIPANTS.

SCAN points may be awarded to both the MARKSMAN and the MARK. Points awarded to the MARKSMAN are dependent on attributes of the MARK/TARGET and whether the MARK/TARGET is associated with a GROUP. Similarly, points awarded to the MARK are dependent on attributes of the MARKSMAN and whether the MARKSMAN is associated with a GROUP.

However, every SCAN does not necessarily result in awarding MARK and/or MARKSMAN points. For example, If the MARKSMAN SCANS a TARGET that is not associated with a PARTICIPANT (i.e., is not REGISTERED), points will not be awarded and the MARKSMAN may be notified. However, if the MARKSMAN scans a TARGET that is not active for the current games, no points are awarded. Optionally, the MARKSMAN can receive confirmation of all SCANS including but not limited to accepted SCANS and declined SCANS, along with the reason for the declining the SCAN. In addition, the number of points awarded to the MARKSMAN, if any.

Moreover, if a non-PARTICIPANT SCANS the TARGET of the MARK, the non-PARTICIPANT's SCAN software displays the website home page 2000 or a special page (i.e., SCAN Landing Page) of the system web site that contains information about the game, and instruction as how to become a PARTICIPANT. Optionally, information about beginning the game, current standings, and currently-offered or previously awarded prizes may be displayed. Specifically, the website SCAN landing page typically may include a brief explanation of the game, links to game resources, information regarding where to purchase TARGETS, information regarding where to purchase smart device apps (e.g., QR reader or similar aps), current game standings and prize information (cash and/or items of value), and advertisements.

As previously discussed, A GROUP consists of one or more TARGETS having at least one common attribute. For example, a restaurant can form a GROUP that includes all of its employees. The GROUP can be configured such that a patron (MARKSMAN) is credited extra points for SCANNING an employee (MARK) and/or a patron (MARK) is credited extra points for being SCANNED by an employee (MARKSMAN).

GROUP/location and radius parameters, business hours, allowed frequency of scans, as well as any other business-imposed conditions may be used to in part to validate a scan and consequently to compute MARK and MARKSMAN points in the context of the GROUP.

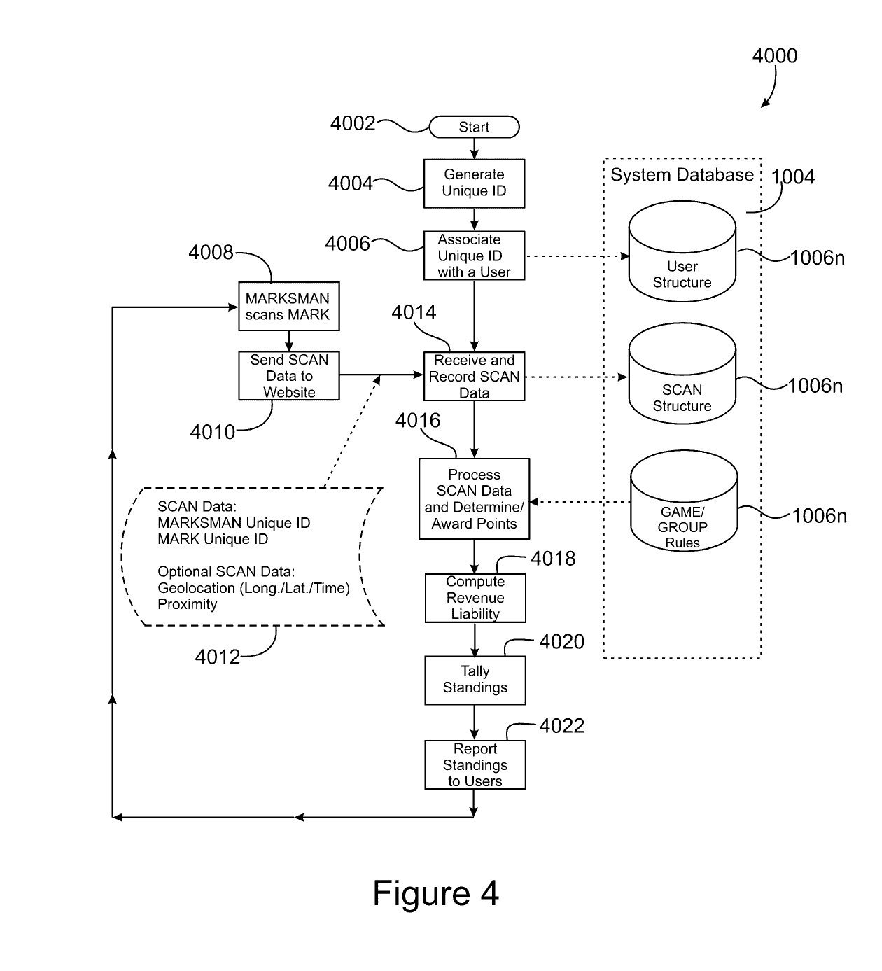

Referring now to FIG. 4, there is shown a greatly simplified flow chart of one aspect of playing the game forming a part of the Performance Based Marketing System Incorporating a Game in accordance with the invention, generally at reference number 4000.

The process starts, Block 4002 with the system generating a unique identifier, often in the form of a TARGET, Block 4004. Typically the TARGET ID is created at the time the TARGET is purchased. This helps avoid potential problems with fraudulent use of pre-assigned TARGET IDs;

The unique identifier, (e.g., a TARGET) is next associated with a potential PARTICIPANT, Block 4006. Association occurs when a user or PARTICIPANT adds the TARGET ID to their account. The unique identifier information is stored in the system database 1004 (FIG. 1), specifically in a user structure tables 1006a, 1006b . . . 1006n (e.g., the Targets table shown in Table I hereinabove). As also discussed hereinabove, TARGETS are made available to potential PARTICIPANTS in a variety of ways. The system can support assigning/associating more than one TARGET to PARTICIPANT. Allowing PARTICIPANTS to own multiple TARGETS is one way to allow a PARTICIPANT to be associated with more than one GROUP and to facilitate gifting.

As shown in FIG. 2Q and previously discussed, new PARTICIPANT accounts may be created via the website.

Once at least two PARTICIPANTS with associated unique identifiers exist in the system, the play aspect of the novel game may be initiated. All play consists of a MARKSMAN (participant with scan tool associated with unique ID (i.e., TARGET)) scanning the unique identifier (i.e., TARGET) of a MARK, Block 4008.

Information (i.e., data) resulting from the SCAN by the MARKSMAN of the MARK is sent to the system (e.g., website), Block 4010. As shown in information break-out 4012, the SCAN data sent generally includes at least the MARKSMAN unique ID, the MARK unique ID. In addition, optional SCAN information such as geolocation data (e.g., latitude, longitude), and time when the scan took place could also be sent.

The SCAN information is recorded with data from the SCAN being stored in the Scan Structure table 1006a, 1006b . . . 1006n of database 1004, Block 4014.

SCAN data is validated based on individual-to-individual criteria, individual-to-business criteria, or business-to-individual criteria and fraudulent scans are flagged. Assuming that the SCAN data is not fraudulent, points to be awarded are determined, Block 4016. Computation of points to be awarded is based on several factors. For example, parameters associated with a specific GAME may determine the number of total times a particular MARKSMAN may scan a particular MARK during the GAME duration. When the TARGET is part of a GROUP, specific rules may be individualized for a particular GROUP. For example, the MARKSMAN may be required to be within a certain distance from a geographic location of a particular branch of the business forming the GROUP. The business may impose frequency of scanning rules. In other examples, a business associated with the GROUP may require an action (e.g., a purchase, a test drive, or other similar action) on the part of the MARKSMAN before points may be awarded.

SCAN submittal may be acknowledged. This is especially important when the SCAN information is invalid. Acknowledgement may be in the form of information at the top of the rendered web site landing page or a pop-up message. Additionally, upon a successful SCAN, customized content may be displayed. For example, current standings of the MARKSMAN can be provided if the MARKSMAN is not currently in the list of top PARTICIPANTS, as represented in current PARTICIPANTS' standings. Instant prizes, server ratings, clues associated with a treasure hunt activity, and/or proximity-triggered coupons, etc. as well as advertisements may also be displayed.

Once points to be awarded are determined, Block 4016, computation is made of revenue due the system, Block 4018. Revenue is computed only when one or both the MARKSMAN and MARK are associated with a GROUP having financial obligation to the system operator. Parameters in the GROUP Table IV such as “Daily Budget”, “Group Type Rate”, “Mark Purchase Required”, etc. may be used to compute the revenue to be paid the system operator for each SCAN.

Once points are awarded, MARKSMAN and MARK points are tallied for each PARTICIPANT, Block 4020.

Standings are then reported via updated information available at the website, Block 4022.

Play may be continued as the server process returns to Block 4008. It will, however be recognized that the processes of Blocks 4004 and 4006 may operate asynchronously relative to the continuing game play of Block 4008 through Block 4022.

As discussed hereinabove, each scanning TOOL must be associated with a PARTICIPANT so that when SCAN data is transmitted to the game server (e.g., website), the data is properly associated with (i.e., credited to) the correct PARTICIPANT user account. TOOL association may be begun by a PARTICIPANT scanning his or her own TARGET or selecting a TARGET when logged into his/her account. If the PARTICIPANT has more than one TARGET, a list of TARGETS may be provided from which the PARTICIPANT may choose. TARGET association may be performed by actions taken on the Manage Targets screen 2740 (FIG. 2S

However, if the TARGET was purchased from the Tag and Be Tagged Store (FIGS. 2M-2P3), the target may be automatically associated with the purchasing PARTICIPANT at the time of purchase. However, the preferred practice is to defer association until the user/PARTICIPANT is ready to use the TARGET in an active game.

Advertising space can be managed on the web site and/or the web site landing page. Advertising space can also be managed on the TOOL. When using a browser-based TOOL, customized content can be displayed when a SCAN is submitted and processed. However, custom applications (i.e., non-browser based TOOL implementations) may have more flexibility than a standard browser. Businesses may be advertised, coupons for the business, or other similar actions may be undertaken when the MARKSMAN or MARK is near an advertiser's location.

The flexibility of the game forming a part of the present invention allows support for numerous group competitions. Such flexibility allows, for example, awarding top employee for game MARK and/or MARKSMAN points earned over a defined time period (e.g., a month, a week, a shift, etc.)

Another example could provide patron-determined MARKSMAN ratings (e.g., the restaurant server could be rated on a scale of 1-10).

Advertising effectiveness rates may be determined based on the percentage of PARTICIPANTS who actually visit a restaurant after seeing advertisement.

Another feature supported by the game is the support for SUB-GAMES (i.e., games within the GAME). Such SUB-GAMES may be PARTICIPANT-created and managed GROUPS for playing games (e.g., commando, team tag, capture the flag, etc.). Tactical instructions and/or information may be displayed on the TOOL,

The novel game also supports creative prize awarding. Some exemplary prize awarding strategies include awarding the highest (or top N) MARKSMAN and/or MARK point tallies, both for the entire game or for periodic intervals within the game duration.

Another possible award strategy could be awarding the PARTICIPANT with the highest combined sum of MARKSMAN and MARK points.

Still another possible award strategy could be awarding the PARTICIPANT with the highest delta tally (MARKSMAN points less MARK points).

A still further possibility is for GROUPS/Businesses to award cash and/or other prizes for standings or points only scored in association with the GROUP or Business.

It will be recognized that unlimited prize awarding strategies may be conceived. Among other possible strategies: randomly awarding prizes to the highest (or top N) PARTICIPANTS, awarding strategic/tactical prizes, awarding a prize to a PARTICIPANT after his/her first SCAN or, alternately, after the first N SCANS, awarding a prize to a PARTICIPANT after his/her first SCAN or, alternately, after the first N SCANS near a specific location, awarding random and/or periodic prizes based on GROUP association (e.g., SCANNING a waiter or bartender may award a coupon or percent off bill or sales item).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of implementing a performance based marketing system incorporating a game, the steps comprising:
a) generating at least one unique identifier for each of a plurality of TARGETS;
b) associating at least two of said plurality of targets with a different one of at least two participants in said game, each of said at least two participants having at least one attribute, said at least one attribute identifying each of said at least two participants as members of a group, said group comprising participants having a common one of said at least one attribute; and
c) allowing a first of said at least two participants to identify and record at least said unique identification of said target associated with the other of said at least two participants.

2. The method of implementing a performance based marketing system incorporating a game as recited in claim 1, the steps further comprising:
d) providing a score to said first of said at least two participants' act of identifying and recording of said at least the unique identification of said target associated with said other of said at least two participants.

3. The method of implementing a performance based marketing system incorporating a game as recited in claim 2, the steps further comprising:
e) tallying said score with scores of other game participants.

4. The method of implementing a performance based marketing system incorporating a game as recited in claim 1, the steps further comprising:
d) providing at least one of said plurality of participants a physical item bearing physical representation of said unique identifier, said physical representation being observable by another one of said plurality of participants.

5. The method of implementing a performance based marketing system incorporating a game as recited in claim 4, wherein said a first of said at least two participants is designated a mark and said other of said at least two participants is designated a marksman.

6. The method of implementing a performance based marketing system incorporating a game as recited in claim 4, wherein said allowing step (c) comprises allowing said first of said at least two participants to observe and then record at least one item of information encoded in said unique identifier in said physical representation.

7. The method of implementing a performance based marketing system incorporating a game as recited in claim 6, wherein said allowing step (c) further comprises also allowing said second of said at least two participants to identify and record the unique identification of a target associated with said first of said at least two participants.

8. The method of implementing a performance based marketing system incorporating a game as recited in claim 7, wherein said providing a score step (e) comprises providing a mark score to said mark and a marksman score to said marksman.

9. The method of implementing a performance based marketing system incorporating a game as recited in claim 8, the steps further comprising:
f) tallying at least one of said mark scores and said marksman scores.

10. The method of implementing a performance based marketing system incorporating a game as recited in claim 9, the steps further comprising:
g) rank ordering at least one of said tallied mark scores and said tallied marksman scores, and
h) awarding recognition to at least one of said at least two participants based on a rank in at least one of said tallied mark scores and said tallied marksman scores.

11. The method of implementing a performance based marketing system incorporating a game as recited in claim 4, wherein said providing a physical item bearing physical representation of said unique identifier step (d) further comprises the sub-step:
i) providing an e-commerce facility enabling each of said at least two participants to acquire said physical item thereat.

12. The method of implementing a performance based marketing system incorporating a game as recited in claim 1, wherein said associating step (b) further comprises an attribute designating said one of said at least two participants with an attribute identifying that participant as a business participant.

13. The method of implementing a performance based marketing system incorporating a game as recited in claim 12, wherein when said one of said at least two participants is identified as a business participant, allowing said identified business participant to perform at least one of the sub-steps:
i) establish a daily budget;
ii) create advertising text to be displayed;
iii) establish group rate mark index;
iv) establish group rate marksman index;
v) establish mark group type scan frequency;
vi) establish marksman group type scan frequency;
vii) establish whether a mark purchase is required; and
viii) establish whether a marksman purchase is required.

14. The method of implementing a performance based marketing system incorporating a game as recited in claim 12, wherein said associating step (b) further comprises associating a physical business location with said business participant.

15. The method of implementing a performance based marketing system incorporating a game as recited in claim 14, wherein said associating step (b) further comprises associating a physical business location with said business participant, said business location having at least one additional business attribute selected from the group: latitude/longitude, operating hours, a changeable advertisement, a logotype, and changeable specials.

16. The method of implementing a performance based marketing system incorporating a game as recited in claim 15, the steps further comprising:
d) displaying an digital map image with said physical location of a participating business displayed thereupon; and
e) when said physical location is selected, displaying business data superimposed upon said digital map image.

17. The method of implementing a performance based marketing system incorporating a game as recited in claim 16, wherein said displaying business data step (e) comprises displaying said physical location and at least one of said additional business attributes.

18. The method of implementing a performance based marketing system incorporating a game as recited in claim 9, the steps further comprising:
g) providing at least one report including information selected from the group: a mark score, a marksman score, a mark tally, and a marksman tally.
